(19) United States
(12) Patent Application Publication
(10) Pub. No.: US 2026/0254686 A1
(43) Pub. Date: Aug. 27, 2026

(54) TECHNIQUES FOR MIXED NUMEROLOGY SLOT FORMATS

(71) Applicant: QUALCOMM Incorporated, San Diego, CA (US)

(72) Inventors: Alexander SVERDLOV, Rehovot (IL); Michael LEVITSKY, Rehovot (IL); Gideon Shlomo KUTZ, Ramat Hasharon (IL); Assaf TOUBOUL, Netanya (IL)

(21) Appl. No.: 19/063,155

(22) Filed: Feb. 25, 2025

(51) Int. Cl. H04L 27/26; H04W 72/0446

(52) U.S. Cl. CPC H04L 27/26025; H04L 27/2646; H04W 72/0446

(57) ABSTRACT

Methods, systems, and devices for wireless communications are described. In some cases, a user equipment (UE) may communicate during a first slot in accordance with a first slot format, where, in accordance with the first slot format, each symbol of the first slot is associated with a first symbol numerology corresponding to a first subcarrier spacing (SCS). Additionally, the UE may receive control signaling indicative of a switch from the first slot format to a second slot format and, thus, may communicate during a second slot in accordance with the second slot format. In accordance with the second slot format, a first subset of symbols of the second slot may be associated with the first symbol numerology and a second subset of symbols of the second slot may be associated with a second symbol numerology corresponding to a second SCS, where the second SCS is different from the first SCS.

### FIELD OF TECHNOLOGY

The following relates to wireless communications, including techniques for mixed numerology slot formats.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include communicating during a first slot in accordance with a first slot format, where, in accordance with the first slot format, each symbol of the first slot is associated with a first symbol numerology corresponding to a first subcarrier spacing (SCS), receiving control signaling indicative of a switch from the first slot format to a second slot format, and communicating during a second slot in accordance with the second slot format based on reception of the control signaling, where, in accordance with the second slot format, a first subset of symbols of the second slot is associated with the first symbol numerology and a second subset of symbols of the second slot is associated with a second symbol numerology corresponding to a second SCS, and where the second symbol numerology is different from the first symbol numerology.

A UE for wireless communications is described. The UE may include one or more memories storing processor executable code, and one or more processors coupled with the one or more memories. The one or more processors may individually or collectively be operable to execute the code to cause the UE to communicate during a first slot in accordance with a first slot format, where, in accordance with the first slot format, each symbol of the first slot is associated with a first symbol numerology corresponding to a first SCS, receive control signaling indicative of a switch from the first slot format to a second slot format, and communicate during a second slot in accordance with the second slot format based on reception of the control signaling, where, in accordance with the second slot format, a first subset of symbols of the second slot is associated with the first symbol numerology and a second subset of symbols of the second slot is associated with a second symbol numerology corresponding to a second SCS, and where the second symbol numerology is different from the first symbol numerology.

Another UE for wireless communications is described. The UE may include means for communicating during a first slot in accordance with a first slot format, where, in accordance with the first slot format, each symbol of the first slot is associated with a first symbol numerology corresponding to a first SCS, means for receiving control signaling indicative of a switch from the first slot format to a second slot format, and means for communicating during a second slot in accordance with the second slot format based on reception of the control signaling, where, in accordance with the second slot format, a first subset of symbols of the second slot is associated with the first symbol numerology and a second subset of symbols of the second slot is associated with a second symbol numerology corresponding to a second SCS, and where the second symbol numerology is different from the first symbol numerology.

A non-transitory computer-readable medium storing code for wireless communications is described. The code may include instructions executable by one or more processors to communicate during a first slot in accordance with a first slot format, where, in accordance with the first slot format, each symbol of the first slot is associated with a first symbol numerology corresponding to a first SCS, receive control signaling indicative of a switch from the first slot format to a second slot format, and communicate during a second slot in accordance with the second slot format based on reception of the control signaling, where, in accordance with the second slot format, a first subset of symbols of the second slot is associated with the first symbol numerology and a second subset of symbols of the second slot is associated with a second symbol numerology corresponding to a second SCS, and where the second symbol numerology is different from the first symbol numerology.

In some examples of the method, UEs, and non-transitory computer-readable medium described herein, the second slot includes one or more downlink symbols, one or more uplink symbols, and a guard period between the one or more downlink symbols and the one or more uplink symbols in a time domain and the guard period includes one or more symbols of the second subset of symbols associated with the second symbol numerology.

In some examples of the method, UEs, and non-transitory computer-readable medium described herein, the one or more symbols of the guard period in the second subset of symbols include a first symbol within the guard period and the second subset of symbols associated with the second symbol numerology further include a last downlink symbol of the one or more downlink symbols that precedes the first symbol within the guard period in the time domain.

In some examples of the method, UEs, and non-transitory computer-readable medium described herein, the one or more symbols of the guard period in the second subset of symbols include a last symbol within the guard period and the second subset of symbols associated with the second symbol numerology further include a first uplink symbol of the one or more uplink symbols that follows the last symbol within the guard period in the time domain.

In some examples of the method, UEs, and non-transitory computer-readable medium described herein, the guard period includes the one or more symbols of the second subset of symbols associated with the second symbol numerology, and one or more additional symbols of the first subset of symbols associated with the first symbol numerology.

Some examples of the method, UEs, and non-transitory computer-readable medium described herein may further include operations, features, means, or instructions for communicating in accordance with the second slot format may be based on the UE communicating via a channel associated with a delay spread satisfying a threshold delay spread, based on the UE communicating in accordance with a modulation and coding scheme (MCS) satisfying a threshold MCS, based on a nominal overhead associated with the UE, based on traffic to be communicated by the UE, based on a quantity of layers associated with the UE, or any combination thereof.

In some examples of the method, UEs, and non-transitory computer-readable medium described herein, in accordance with the second slot format, a third subset of symbols of the second slot may be associated with a third symbol numerology, different from the first symbol numerology and the second symbol numerology.

In some examples of the method, UEs, and non-transitory computer-readable medium described herein, the second slot includes one or more downlink symbols, one or more uplink symbols, and a guard period between the one or more downlink symbols and the one or more uplink symbols in a time domain, and and the guard period includes one or more symbols of the third subset of symbols associated with the third symbol numerology.

In some examples of the method, UEs, and non-transitory computer-readable medium described herein, the control signaling includes a radio resource control (RRC) message and the switch from the first slot format to the second slot format may be indicated based on one or more information elements (IEs) of the RRC message indicating the second slot format, the second symbol numerology, or both.

In some examples of the method, UEs, and non-transitory computer-readable medium described herein, the one or more IEs includes a first IE that indicates that the second subset of symbols includes one or more downlink symbols, a second IE that indicates that the second subset of symbols includes one or more uplink symbols, or both.

In some examples of the method, UEs, and non-transitory computer-readable medium described herein, the control signaling includes medium access control-control element message, a downlink control information message, or both.

In some examples of the method, UEs, and non-transitory computer-readable medium described herein, the second symbol numerology may be greater than the first symbol numerology and the second SCS may be greater than the first SCS based on the second symbol numerology being greater than the first symbol numerology.

In some examples of the method, UEs, and non-transitory computer-readable medium described herein, each symbol in the first subset of symbols may be associated with a first duration and each symbol in the second subset of symbols may be associated with a second duration that may be half of the first duration.

A method for wireless communications by a network entity is described. The method may include communicating during a first slot in accordance with a first slot format, where, in accordance with the first slot format, each symbol of the first slot is associated with a first symbol numerology corresponding to a first SCS, transmitting control signaling indicative of a switch from the first slot format to a second slot format, and communicating during a second slot in accordance with the second slot format based on transmission of the control signaling, where, in accordance with the second slot format, a first subset of symbols of the second slot is associated with the first symbol numerology and a second subset of symbols of the second slot is associated with a second symbol numerology corresponding to a second SCS, and where the second symbol numerology is different from the first symbol numerology.

A network entity for wireless communications is described. The network entity may include one or more memories storing processor executable code, and one or more processors coupled with the one or more memories. The one or more processors may individually or collectively be operable to execute the code to cause the network entity to communicate during a first slot in accordance with a first slot format, where, in accordance with the first slot format, each symbol of the first slot is associated with a first symbol numerology corresponding to a first SCS, transmit control signaling indicative of a switch from the first slot format to a second slot format, and communicate during a second slot in accordance with the second slot format based on transmission of the control signaling, where, in accordance with the second slot format, a first subset of symbols of the second slot is associated with the first symbol numerology and a second subset of symbols of the second slot is associated with a second symbol numerology corresponding to a second SCS, and where the second symbol numerology is different from the first symbol numerology.

Another network entity for wireless communications is described. The network entity may include means for communicating during a first slot in accordance with a first slot format, where, in accordance with the first slot format, each symbol of the first slot is associated with a first symbol numerology corresponding to a first SCS, means for transmitting control signaling indicative of a switch from the first slot format to a second slot format, and means for communicating during a second slot in accordance with the second slot format based on transmission of the control signaling, where, in accordance with the second slot format, a first subset of symbols of the second slot is associated with the first symbol numerology and a second subset of symbols of the second slot is associated with a second symbol numerology corresponding to a second SCS, and where the second symbol numerology is different from the first symbol numerology.

A non-transitory computer-readable medium storing code for wireless communications is described. The code may include instructions executable by one or more processors to communicate during a first slot in accordance with a first slot format, where, in accordance with the first slot format, each symbol of the first slot is associated with a first symbol numerology corresponding to a first SCS, transmit control signaling indicative of a switch from the first slot format to a second slot format, and communicate during a second slot in accordance with the second slot format based on transmission of the control signaling, where, in accordance with the second slot format, a first subset of symbols of the second slot is associated with the first symbol numerology and a second subset of symbols of the second slot is associated with a second symbol numerology corresponding to a second SCS, and where the second symbol numerology is different from the first symbol numerology.

In some examples of the method, network entities, and non-transitory computer-readable medium described herein, the second slot includes one or more downlink symbols, one or more uplink symbols, and a guard period between the one or more downlink symbols and the one or more uplink symbols in a time domain and the guard period includes one or more symbols of the second subset of symbols associated with the second symbol numerology.

In some examples of the method, network entities, and non-transitory computer-readable medium described herein, the one or more symbols of the guard period in the second subset of symbols include a first symbol within the guard period and the second subset of symbols associated with the second symbol numerology further include a last downlink symbol of the one or more downlink symbols that precedes the first symbol within the guard period in the time domain.

In some examples of the method, network entities, and non-transitory computer-readable medium described herein, the one or more symbols of the guard period in the second subset of symbols include a last symbol within the guard period and the second subset of symbols associated with the second symbol numerology further include a first uplink symbol of the one or more uplink symbols that follows the last symbol within the guard period in the time domain.

In some examples of the method, network entities, and non-transitory computer-readable medium described herein, the guard period includes the one or more symbols of the second subset of symbols associated with the second symbol numerology, and one or more additional symbols of the first subset of symbols associated with the first symbol numerology.

Some examples of the method, network entities, and non-transitory computer-readable medium described herein may further include operations, features, means, or instructions for selecting the second slot format based on communicating via a channel associated with a delay spread satisfying a threshold delay spread, based on communicating in accordance with a MCS satisfying a threshold MCS, based on a nominal overhead associated with a UE, based on traffic to be communicated by the network entity, based on a quantity of layers associated with the UE, or any combination thereof.

In some examples of the method, network entities, and non-transitory computer-readable medium described herein, in accordance with the second slot format, a third subset of symbols of the second slot may be associated with a third symbol numerology, different from the first symbol numerology and the second symbol numerology.

In some examples of the method, network entities, and non-transitory computer-readable medium described herein, the second slot includes one or more downlink symbols, one or more uplink symbols, and a guard period between the one or more downlink symbols and the one or more uplink symbols in a time domain, and and the guard period includes one or more symbols of the third subset of symbols associated with the third symbol numerology.

In some examples of the method, network entities, and non-transitory computer-readable medium described herein, the control signaling includes a RRC message and the switch from the first slot format to the second slot format may be indicated based on one or more IEs of the RRC message indicating the second slot format, the second symbol numerology, or both.

In some examples of the method, network entities, and non-transitory computer-readable medium described herein, the one or more IEs includes a first IE that indicates that the second subset of symbols includes one or more downlink symbols, a second IE that indicates that the second subset of symbols includes one or more uplink symbols, or both.

In some examples of the method, network entities, and non-transitory computer-readable medium described herein, the control signaling includes medium access control-control element message, a downlink control information message, or both.

In some examples of the method, network entities, and non-transitory computer-readable medium described herein, the second symbol numerology may be greater than the first symbol numerology and the second SCS may be greater than the first SCS based on the second symbol numerology being greater than the first symbol numerology.

In some examples of the method, network entities, and non-transitory computer-readable medium described herein, each symbol in the first subset of symbols may be associated with a first duration and each symbol in the second subset of symbols may be associated with a second duration that may be half of the first duration.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for mixed numerology slot formats in accordance with one or more aspects of the present disclosure.

FIG. 2 shows an example of a wireless communications system that supports techniques for mixed numerology slot formats in accordance with one or more aspects of the present disclosure.

FIG. 3 shows examples of slot formats that support techniques for mixed numerology slot formats in accordance with one or more aspects of the present disclosure.

FIG. 4 shows an example of a symbol diagram that supports techniques for mixed numerology slot formats in accordance with one or more aspects of the present disclosure.

FIG. 5 shows examples of slot formats that support that supports techniques for mixed numerology slot formats in accordance with one or more aspects of the present disclosure.

FIG. 6 shows an example of a process flow that supports techniques for mixed numerology slot formats in accordance with one or more aspects of the present disclosure.

FIGS. 7 and 8 show block diagrams of devices that support techniques for mixed numerology slot formats in accordance with one or more aspects of the present disclosure.

FIG. 9 shows a block diagram of a communications manager that supports techniques for mixed numerology slot formats in accordance with one or more aspects of the present disclosure.

FIG. 10 shows a diagram of a system including a device that supports techniques for mixed numerology slot formats in accordance with one or more aspects of the present disclosure.

FIGS. 11 and 12 show block diagrams of devices that support techniques for mixed numerology slot formats in accordance with one or more aspects of the present disclosure.

FIG. 13 shows a block diagram of a communications manager that supports techniques for mixed numerology slot formats in accordance with one or more aspects of the present disclosure.

FIG. 14 shows a diagram of a system including a device that supports techniques for mixed numerology slot formats in accordance with one or more aspects of the present disclosure.

FIGS. 15 and 16 show flowcharts illustrating methods that support techniques for mixed numerology slot formats in accordance with one or more aspects of the present disclosure.

### DETAILED DESCRIPTION

In some wireless communications system, wireless devices, (e.g., user equipments (UEs) and network entities) may communicate via slots that include uplink symbols and downlink symbols. In such cases, the slots may further include a guard period, including one or more guard period symbols, between the downlink symbols and the uplink symbols due to propagation delay (PD) between transmission of a message by a network entity and reception of the message by the UE (e.g., and visa-versa). In other words, the network entity may transmit a downlink message within a downlink symbol, however, due to the PD, the UE may receive the downlink message at least partially within a next symbol after the downlink symbol. Thus, if the next symbol is an uplink symbol, the downlink message may interfere with the uplink message. As such, the slot may include guard period symbols after the downlink symbol (e.g., between the downlink symbol and the uplink symbol) to account for the PD, and to enable the UE to re-tune one or more radio frequency (RF) components to switch between downlink and uplink communications. In such cases, the guard period symbols may be associated with a same numerology (e.g., a same sub-carrier spacing (SCS)) as the downlink symbols and the uplink symbols. However, the inclusion of the guard period symbols may result in a less efficient use of resources (e.g., as compared to cases with no guard period symbols), as communications may not be scheduled within the guard period symbols. Moreover, depending on the SCS of the slot, the length of the guard period symbols may be longer than a first threshold duration associated with overlap between downlink and uplink communications, longer than a second threshold duration associated with retuning the one or more RF components, or both. Stated differently, depending on the SCS of the slot, the duration of the guard period symbols may be longer than necessary to account for the PD between the devices and/or longer than necessary for retuning RF components, thereby resulting in “wasted” resources.

Accordingly, techniques described herein may enable the wireless devices to support a slot format with mixed numerologies (e.g., symbols with different SCSs) and, more specifically, with one or more guard period symbols associated with a different numerology as compared to one or more other symbols (e.g., uplink symbols, downlink symbols, or both) in a slot. For example, a UE may communicate via a first slot in accordance with a first slot format, such that each symbol in the first slot may be associated with the same numerology (e.g., a first numerology associated with a first SCS). Additionally, the UE may receive control signaling indicating a switch from the first slot format to a second slot format, such that the UE may communicate via a second slot in accordance with the second slot format based on reception of the control signaling. In such cases, in accordance with the second slot, the second slot may include a first subset of symbols associated with the first numerology (e.g., the first SCS) and a second subset of symbols associated with a second numerology (e.g., associated with a second SCS) that is different than the first numerology.

In particular, a guard period between a downlink symbol and an uplink symbol may include a set of guard period symbols and the UE may apply the second numerology to at least one or more guard period symbols from the set of guard period symbols. That is, the one or more guard period symbols may be associated with the second SCS (e.g., different SCS), and may therefore exhibit a different length in the time domain as compared to the other downlink/uplink symbols of the slot (e.g., guard period symbols may be shorter than uplink/downlink symbols). Additionally, or alternatively, the downlink symbol, the uplink symbol, or both, adjacent to the set of guard period symbols may also be associated with the second numerology. By enabling one or more guard period symbols to be associated with a different numerology (e.g., different SCS), aspects of the present disclosure may enable the length of the guard period to be tailored (e.g., shortened), thereby leading to more efficient use of resources (e.g., as compared to guard period symbols with a same SCS as other symbols in the slot).

Aspects of the disclosure are initially described in the context of wireless communications systems. Aspects of the disclosure are then described in the context of slot formats, a symbol diagram, and a process flow. Aspects of the disclosure are further illustrated by and described with reference to apparatus diagrams, system diagrams, and flowcharts that relate to techniques for mixed numerology slot formats.

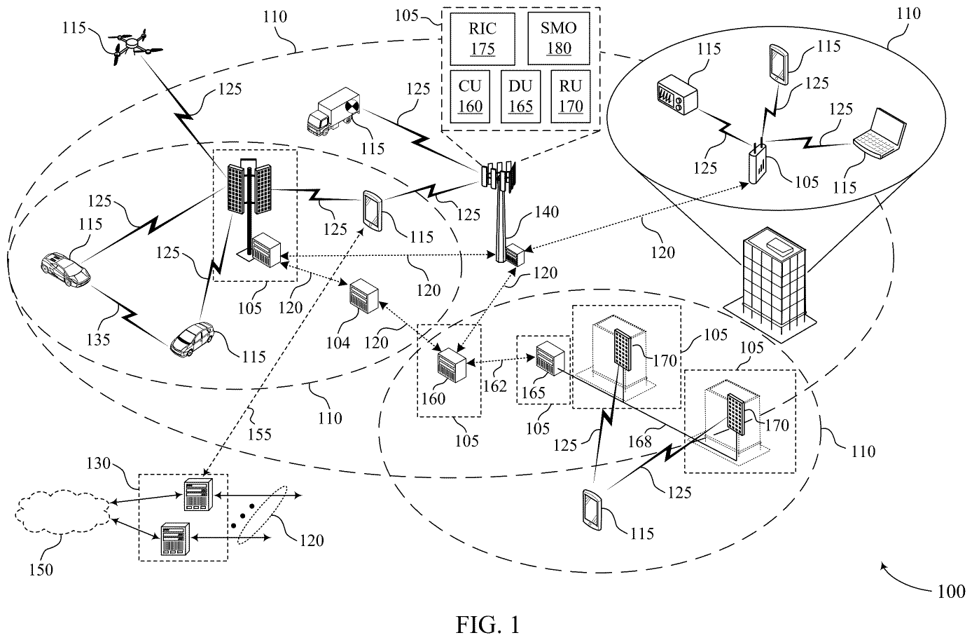

FIG. 1 shows an example of a wireless communications system 100 that supports techniques for mixed numerology slot formats in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support techniques for mixed numerology slot formats as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing (SCS) may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a SCS (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported SCS, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on SCS. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the SCS or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the wireless devices of the wireless communications system 100 may support a slot format with mixed numerologies (e.g., different SCSs). More specifically, the wireless devices of the wireless communications system 100 may support a slot format with one or more symbols in a guard period associated with a different numerology as compared to one or more other symbols of the slot. For example, a UE 115 may communicate, with a network entity 105, via a first slot in accordance with a first slot format, where each symbol in the first slot may be associated with the same numerology (e.g., a first numerology corresponding to a first SCS) in accordance with the first slot format. Additionally, the UE 115 may receive, from the network entity 105, control signaling indicating a switch from the first slot format to the second slot format, such that the UE 115 may communicate, with the network entity 105, via a second slot in accordance with the second slot format based on reception of the control signaling. In such cases, the second slot may include a first subset of symbols associated with the first numerology (e.g., the first SCS) and a second subset of symbols associated with a second numerology (e.g., corresponding to a second SCS), where the second numerology is different than the first numerology.

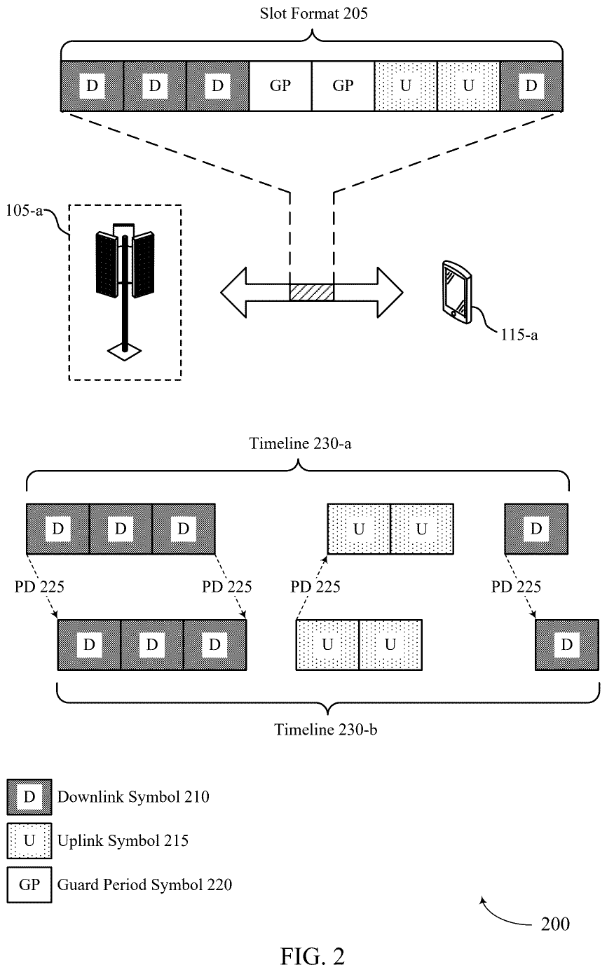

FIG. 2 shows an example of a wireless communications system 200 that supports techniques for mixed numerology slot formats in accordance with one or more aspects of the present disclosure. In some cases, the wireless communications system 200 may implement, or be implemented by, aspects of the wireless communications system 100. For example, the wireless communications system 200 may include one or more UEs 115 (e.g., a UE 115-a) and one or more network entities 105 (e.g., a network entity 105-a), which may be examples of the corresponding devices as described herein.

In some wireless communications systems, such as the wireless communications system 200, wireless devices, such as the UE 115-a and the network entity 105-a, may communicate via one or more slots associated with a slot format 205, where each slot (e.g., of the one or more slots) includes one or more downlink symbols 210 and one or more uplink symbols 215 (e.g., in accordance with the slot format 205). In such cases, each slot may further include a guard period, including one or more guard period symbols 220, between the one or more downlink symbols 210 and the one or more uplink symbols 215 due to a PD 225 between transmission of a message by the network entity 105-a and reception of the message by the UE 115-a (e.g., and visa-versa). In other words, the network entity 105-a may communicate in accordance with a timeline 230-a (e.g., a network entity timeline) and the UE 115-a may communicate in accordance with a timeline 230-b (e.g., a UE timeline), where the timeline 230-a is different than the timeline 230-b based on the PD 225. As such, the network entity 105-a may transmit a message within a downlink symbol 210 of a slot (e.g., at a nominal symbol boundary), however, due to the PD 225, the UE 115-a may receive the message at least partially within a next symbol in the slot, after the downlink symbol 210. Thus, the slot may include one or more guard period symbols 220 between the downlink symbol 210 and an uplink symbol 215 to account for the PD 225 (e.g., to avoid the UE 115-a receiving the message in an uplink symbol 215), and to enable the UE 115-a to re-tune one or more RF components to switch between downlink and uplink communications.

In some cases, the slot format 205 may include one or more guard period symbols 220 (e.g., a guard period) between one or more downlink symbols 210 and one or more uplink symbols 215 (e.g., a switch from downlink communications to uplink communications), between one or more uplink symbols 215 and one or more downlink symbols 210 (e.g., a switch from uplink communications to downlink communications), or both. Alternatively, in some cases, the slot format may not include one or more guard period symbols 220 between the one or more uplink symbols 215 and the one or more downlink symbols 210 (e.g., the switch from uplink communications to downlink communications). That is, the network entity 105-a may account for a timing advance associated with uplink transmissions by the UE 115-a, such that the network entity 105-a may be capable of completing reception of an uplink message from the UE 115-a via an uplink symbol 215 (e.g., reception of one or more uplink symbols 215) a threshold duration prior to a subsequent downlink symbol 210 (e.g., early enough) to enable the network entity 105-a to transition from reception of uplink messages to transmission of downlink messages prior to a boundary of the subsequent downlink symbol 210.

Additionally, or alternatively, a duration of the one or more guard period symbols 220 (e.g., a duration of the guard period, GP_duration) may be based on a round-trip delay between the network entity 105-a and the UE 115-a. For example, the duration of the one or more guard period symbols 220 may be greater than or equal to a first threshold (e.g., minimum) duration (e.g., GP_duration≥GP_duration_min), where the first threshold duration is based on (e.g., equal to) the round trip delay (which may be based on PD 225), a first latency associated with a switch (e.g., transition) from uplink communications to downlink communications (e.g., a reception to transmission latency for the network entity 105-a, a transmission to reception latency for the UE 115-a), a second latency associated with a switch (e.g., transition) from downlink communications to uplink communications (e.g., a reception to transmission latency for the UE 115-a, a transmission to reception latency for the network entity 105-a), or any combination thereof (e.g., GP_{duration}_{ₘᵢₙ}=RoundTripDelay+TX2RX_{latency}+RX2TX_latency).

In some cases, all symbols (e.g., downlink symbols 210, uplink symbols 215, and guard period symbols 220) within a slot may be associated with (e.g., use) a same numerology in accordance with the slot format 205. Thus, the guard period may include an integer quantity of (e.g., one or more) guard period symbols 220. In other words, the one or more guard period symbols 220 may be associated with a same numerology and the one or more downlink symbols 210 and the one or more uplink symbols 215. Therefore, all the symbols of the slot format 205 may be the same length, as shown in FIG. 2. However, inclusion of the one or more guard period symbols 220 within a slot may result in an inefficient use of resources, as communications may not be scheduled within the one or more guard period symbols 220. Moreover, depending on the numerology (e.g., SCS) of the slot, the duration of the one or more guard period symbols 220 may be longer than a second threshold duration associated with switching from downlink communications to uplink communications (e.g., or visa-versa), longer than a third threshold duration associated with re-tuning one or more RF components, or both. Stated differently, depending on the SCS of the slot, the duration of the guard period symbols 220 may be longer than necessary to account for the PD 225 between the devices and/or longer than necessary for retuning RF components, thereby resulting in “wasted” resources. In some examples, the duration of the one or more guard period symbols 220 may exceed the second threshold duration, the third threshold duration, or both, by up to one symbol per transition between uplink communications and downlink communications (e.g., a potential traffic loss and overhead may be up to one symbol per downlink to uplink transition, uplink to downlink transition, or both).

For example, traffic loss due to a transition (e.g., switch) between downlink communications and uplink communications (e.g., downlink to uplink and uplink to downlink) may be represented according to a ratio between the traffic loss and a total available traffic, which may be referred to as a traffic loss ratio and may be a function of a transition rate associated with the transition between downlink communications and uplink communications (e.g., DL-UL transition rate). In some cases, one or more use cases may be associated with traffic loss ratios exceeding a threshold (e.g., a significant traffic loss ratio) For example, the one or more use cases may include low latency traffic associated with a transition rate exceeding a threshold transition rate (e.g., a high DL-UL transition rate), such as ultra-reliable low-latency communications (URLLC) (e.g., for a set of slot lengths). Additionally, or alternatively, the one or more use cases may include NR uplink communications (e.g., NR-U) that enable a network to operate in one or more unlicensed channels (e.g., including sub-7 GHz bands where transmitters may adhere to a set of contention resolution rules, which may be referred to as listen before talk (LBT)).

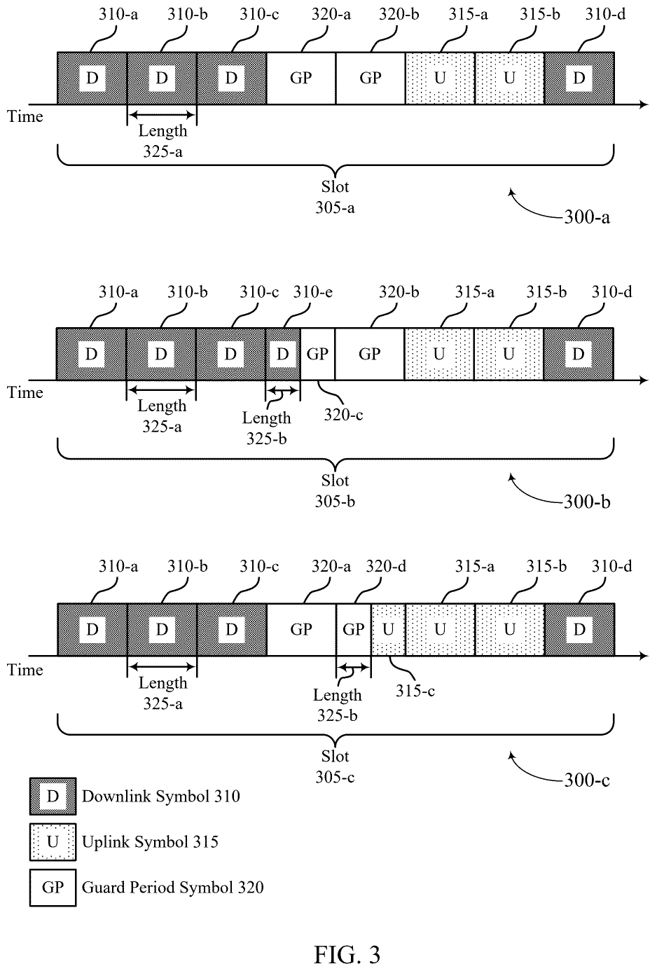

Accordingly, in some cases, the wireless communications system 200 may support an additional slot format 205 associated with mixed numerologies (e.g., different SCSs) and, more specifically, a slot with one or more guard period symbols 220 associated with a different numerology as compared to one or more other symbols of the slot (e.g., in accordance with the additional slot format 205), as described further with reference to FIGS. 3 through 5. For example, the UE 115-a may communicate, with the network entity 105-a, via a first slot in accordance with the slot format 205, where each symbol in the first slot may be associated with the same numerology (e.g., a first numerology corresponding to a first SCS) in accordance with the slot format 205. That is, in accordance with the first slot format 205, every symbol of the slot may be associated with the same SCS, and therefore exhibit the same length.

Continuing with the same example, in accordance with aspects of the present disclosure, the UE 115-a may receive, from the network entity 105-a, control signaling indicating a switch from the slot format 205 to the additional slot format 205, such that the UE 115-a may communicate, with the network entity 105-a, via a second slot in accordance with the additional slot format 205 based on reception of the control signaling. In such cases, the second slot may include a first subset of symbols associated with the first numerology (e.g., the first SCS) and a second subset of symbols associated with a second numerology (e.g., corresponding to a second SCS), where the second numerology is different than the first numerology, as described further with reference to FIGS. 3 through 5. That is, in accordance with the second slot format 205, the slot may exhibit symbols that are associated with different SCSs, and therefore exhibit different lengths. In particular, in some cases, guard period symbols 220 may be shorter than other symbols of the slot (in accordance with the second slot format).

In some examples, such as with URLLC, supporting mixed numerologies within a slot may enable the UE 115-a and the network entity 105-a to support a finer TDM granularity of scheduling for a same or different UEs 115 within the slot (e.g., as compared to a slot with a same numerology). Additionally, or alternatively, supporting mixed numerologies within a slot may enable additional switching points to increase a probability for both uplink and downlink per channel occupancy time (COT) (e.g., as compared to a slot with a same numerology). That is, NR uplink communications, as described herein, may be associated with a scheduled RAT where transmissions begin (e.g., are expected to begin) at fixed slot boundaries. However, an end of an LBT procedure may not coincide (e.g., align) with a fixed slot boundary. Thus, supporting mixed numerologies within a slot may increase a probability that that an LBT procedure coincides with a fixed slot boundary (e.g., as compared to slots with a same numerology).

FIG. 3 shows examples of slot formats 300 (e.g., a slot format 300-a, a slot format 300-b, and a slot format 300-c) that support techniques for mixed numerology slot formats in accordance with one or more aspects of the present disclosure. In some cases, the slot formats 300 may be implemented by aspects of the wireless communications system 100, the wireless communications system 200, or both. For example, the slot formats 300 may be implemented by one or more UEs 115 and one or more network entities 105, which may be examples of the corresponding devices as described herein.

As described with reference to FIG. 2, in some cases, a slot format 300, such as the slot format 300-a, may include symbols with a same numerology (e.g., same SCS). For example, in accordance with the slot format 300-a, a slot 305-a may include a downlink symbol 310-a, a downlink symbol 310-b, a downlink symbol 310-c, a guard period symbol 320-a, a guard period symbol 320-b, an uplink symbol 315-a, an uplink symbol 315-b, and a downlink symbol 310-d, where each downlink symbol 310, each uplink symbol 315, and each guard period symbol 320 may be associated with a same numerology (e.g., μ=N for the slot 305-a). That is, each symbol in the slot 305-a may be associated with the same SCS, and therefore may all exhibit a same length 325-a (e.g., same duration in the time domain). However, as described herein, using the same numerology for all symbols in the slot 305 may result in inefficient resource utilization. In particular, the guard period symbols 320-a, 320-b may be longer than necessary to account for PD 225 and/or to retune RF components, resulting in an inefficient use of resources.

As such, as described with reference to FIG. 2, wireless devices, such as a UE 115 and a network entity 105 may support mixed numerology slot formats 300, such as the slot format 300-b and the slot format 300-c. That is, in accordance with a mixed numerology slot format 300, a slot 305 may include a first subset of symbols associated with a first numerology (e.g., a first SCS) and a second subset of symbols associated with a second numerology (e.g., different than the first numerology, a second SCS), where the second subset of symbols includes at least one or more guard period symbols 320.

For example, in accordance with the slot format 300-b, a slot 305-b may include the downlink symbol 310-a, the downlink symbol 310-b, the downlink symbol 310-c, a downlink symbol 310-e, a guard period symbol 320-c, the guard period symbol 320-b, the uplink symbol 315-a, the uplink symbol 315-b, and the downlink symbol 310-d. In such cases, the downlink symbol 310-a, the downlink symbol 310-b, the downlink symbol 310-c, the guard period symbol 320-b, the uplink symbol 315-a, the uplink symbol 315-b, and the downlink symbol 310-d may be associated with a first numerology (e.g., first SCS, μ=N), and the downlink symbol 310-e and the guard period symbol 320-c may be associated with a second numerology (e.g., second SCS, μ=N+1), where the second numerology is different than the first numerology. In this regard, the downlink symbol 310-e and the guard period symbol 320-c may be shorter (in the time domain) than the other symbols of the slot 305-b. For example, the downlink symbol 310-e and the guard period symbol 320-c may be of a length 325-b, while other symbols in the slot 305-b, such as the downlink symbol 310-b, may be of the length 325-a, where the length 325-b is shorter than the length 325-a.

The downlink symbol 310-e may be associated with the second numerology based on the downlink symbol 310-e being a downlink symbol 310 adjacent to a guard period including the guard period symbol 320-c and the guard period symbol 320-b (e.g., a last downlink symbol 310, in a time domain, prior to the guard period). In other words, the second numerology (e.g., second SCS) may be applied to the guard period symbol 320-c based on the guard period symbol 320-c falling between the downlink symbols 310 and the uplink symbols 325 in the time domain. Similarly, the second numerology (e.g., second SCS) may be applied to the downlink symbol 310-e based on the downlink symbol 310-e immediately preceding the guard period symbols 320.

In another example, in accordance with the slot format 300-c, a slot 305-c may include the downlink symbol 310-a, the downlink symbol 310-b, the downlink symbol 310-c, the guard period symbol 320-a, a guard period symbol 320-d, an uplink symbol 315-c, the uplink symbol 315-a, the uplink symbol 315-b, and the downlink symbol 310-d. In such cases, the downlink symbol 310-a, the downlink symbol 310-b, the downlink symbol 310-c, the guard period symbol 320-a, the uplink symbol 315-a, the uplink symbol 315-b, and the downlink symbol 310-d may be associated with the first numerology (e.g., first SCS, μ=N), and the guard period symbol 320-d and the uplink symbol 315-c may be associated with the second numerology (e.g., second SCS, μ=N+1). In this regard, the guard period symbol 320-d and the uplink symbol 315-c may be shorter than the other symbols of the slot 305-c. For example, the guard period symbol 320-d and the uplink symbol 315-c may be of the length 325-b, while other symbols in the slot 305-c, such as the downlink symbol 310-b, may be of the length 325-a, where the length 325-b is shorter than the length 325-a.

The uplink symbol 315-c may be associated with the second numerology based on the uplink symbol 315-c being an uplink symbol 315 adjacent to a guard period including the guard period symbol 320-a and the guard period symbol 320-d (e.g., a first uplink symbol 315, in the time domain, after the guard period). In other words, the second numerology (e.g., second SCS) may be applied to the guard period symbol 320-d based on the guard period symbol 320-d falling between the downlink symbols 310 and the uplink symbols 325 in the time domain. Similarly, the second numerology (e.g., second SCS) may be applied to the uplink symbol 315-c based on the uplink symbol 315-c immediately following the guard period symbols 320.

In some cases, the second numerology may be higher (e.g., greater) than the first numerology. For example, the second numerology may be higher than the first numerology, such that a second symbol duration associated with the second numerology is half of a first symbol duration associated with the first numerology. Thus, the downlink symbol 310-e, the uplink symbol 315-c, or both, being associated with the second numerology may enable the UE 115-a to use (e.g., save) up to an additional half-symbol length per downlink to uplink transition (e.g., or visa-versa), as compared to the slot format 300-a, thus enabling the UE 115 to reduce throughput loss (e.g., as compared to the slot format 300-a).

As described further with reference to FIG. 3, supporting the slot format 300-b, the slot format 300-c, or both, may result in performance degradation to communications due to a shorter cyclic prefix (CP) length (e.g., CP length less than a threshold CP length), a larger SCS (e.g., SCS exceeding a threshold SCS), or both. For example, for channels with a delay spread (DS) exceeding a threshold DS, the shorter CP length may result in residual inter-symbol interference (ISI), which may further result in the performance degradation. Additionally, or alternatively, the performance degradation may be based on an MCS (e.g., waveform) used (e.g., supported by, configured for) the UE 115, such that an MCS exceeding a threshold MCS (e.g., high MCS) may experience more performance degradation due to the larger SCS than an MCS less than the threshold MCS (e.g., low MCS).

As such, a UE 115, a network entity 105, or both, may select the slot format 300-a (e.g., legacy format, single numerology for all symbols), the slot format 300-b (e.g., one or more additional downlink symbols 310 with a higher numerology), or the slot format 300-c (e.g., one or more additional uplink symbols 315 with the higher numerology) based on one or more selection criteria. In such cases, the one or more selection criteria may include a nominal overhead (OH), an uplink priority (e.g., depending on traffic per UE 115), a downlink priority (e.g., depending on traffic per UE 115), a target MCS, channel conditions (e.g., channel selectivity), a quantity of layers (e.g., single layer vs multiple layer transmissions, to reduce sensitivity to channel estimation (CHEST) errors due to a higher SCS), or any combination thereof. For example, if the nominal OH is greater than or equal to a symbol length divided by 2

$$( e . g . , Nominal OH \geq \frac{symbol length}{2} ) ,$$

the network entity 105 may select the slot format 300-b or the slot format 300-c. Otherwise

$$( e . g . , Nominal OH < \frac{symbol length}{2} ) ,$$

the network entity 105 may select the slot format 300-a.

For example, the network entity 105 may select the slot format 300-b or the slot format 300-c for new data traffic (e.g., with one or more limitations on link conditions and MCS due to potential performance degradations), for control information (e.g., due to a control channel being associated with a target error vector magnitude (EVM) exceeding a threshold EVM), for repetitions of existing data (e.g., repetitions of a same TB, such as in fast-fading scenarios), for front loaded demodulation reference signals (DMRS), for a calibration waveform, or any combination thereof.

In some examples, the network entity 105 may configure the UE 115 to switch between the slot format 300-a, the slot format 300-b, slot format 300-c, or any combination thereof, via control signaling. For example, in some cases, network entity 105 may configure the UE 115 to support (e.g., to switch to) the slot format 300-b, the slot format 300-c, or both, via RRC signaling (e.g., for static or semi-static configurations). For example, the RRC signaling may include a tdd-UL-DL-configurationCommon information element (IE) (e.g., common for all UEs 115) or a tdd-UL-DL-ConfigDedicated IE (e.g., dedicated for a specific UE 115) including a TDD-UL-DL-pattern IE in accordance with the following signaling:

| | |
|---|---|
| dl-UL-TransmissionPeriodicity | ENUMERATED {ms0p5, ms0p625, ms1, |
| | ms1p25, ms2, ms2p5, ms5, ms10}, |
| nrofDownlinkSlots | INTEGER (0.maxNrofSlots), |
| nrofDownlinkSymbols | INTEGER (0.maxNrofSymbols−1), |
| shortDownlinkSymbolEn | BOOL (false, true) |
| nrofUplinkSlots | INTEGER (0.maxNrofSlots), |
| nrofUplinkSymbols | INTEGER (0.maxNrofSymbols−1), |
| shortUplinkSymbolEn | BOOL (false, true) |
| . . . | |

dl-UL-TransmissionPeriodicity-v1530 ENUMERATED {ms3, ms4}
OPTIONAL - Need R

In such cases, the shortDownlinkSymbolEn IE may indicate the slot format 300-b is supported (e.g., shorter downlink symbols 310 with higher numerologies, as compared to downlink symbols 310 in accordance with the slot format 300-a, are supported) and the shortUplinkSymbolEn IE may indicate the slot format 300-c is supported (e.g., shorter uplink symbols 315 with higher numerologies, as compared to uplink symbols 315 in accordance with the slot format 300-a, are supported).

Additionally, or alternatively, (e.g., due to RRC configurations and reconfigurations resulting in link interruptions, for dynamic changes), the network entity 105 may configure the UE 115 to switch between the slot format 300-a, the slot format 300-b, slot format 300-c, or any combination thereof, via MAC-CE signaling. For example, the MAC-CE signaling may include a CE (e.g., an additional CE or a new CE) indicating the switch between the slot format 300-a, the slot format 300-b, slot format 300-c, or any combination thereof. The network entity 105 may configure the UE 115 to switch to between the slot format 300-a, the slot format 300-b, slot format 300-c, or any combination thereof, via MAC-CE signaling to avoid link interruptions.

Additionally, or alternatively, (e.g., for dynamic changes, for slot-based reconfigurations), the network entity 105 may configure the UE 115 to between the slot format 300-a, the slot format 300-b, slot format 300-c, or any combination thereof, via downlink control information (DCI) signaling. For example, in some cases, the DCI signaling may include one or more bits indicating the switch between the slot format 300-a, the slot format 300-b, slot format 300-c, or any combination thereof. Additionally, or alternatively, the DCI signaling may include an additional field (e.g., to the BWP) indicating the switch between the slot format 300-a, the slot format 300-b, slot format 300-c, or any combination thereof (e.g., using a relevant BWP index).

In some cases, a slot format 300-d (e.g., not depicted) may include both the downlink symbol 310-e and the uplink symbol 315-c (e.g., associated with the second numerology). That is, both the last downlink symbol 310 prior to the guard period and the first uplink symbol 315 after the guard period (e.g., both symbols adjacent to the guard period) may be associated with the second numerology.

Though described in the context of a transition (e.g., switch) from downlink communications to uplink communications in which a slot 305 includes one or more guard period symbols 320 between a downlink symbol 310 and an uplink symbol 315, this is not to be regarded as a limitation of the present disclosure. In this regard, techniques described herein may additionally, or alternatively, be applicable to a transition from uplink communications to downlink communications in which a slot 305 includes one or more guard period symbols 320 between an uplink symbol 315 and a downlink symbol 310.

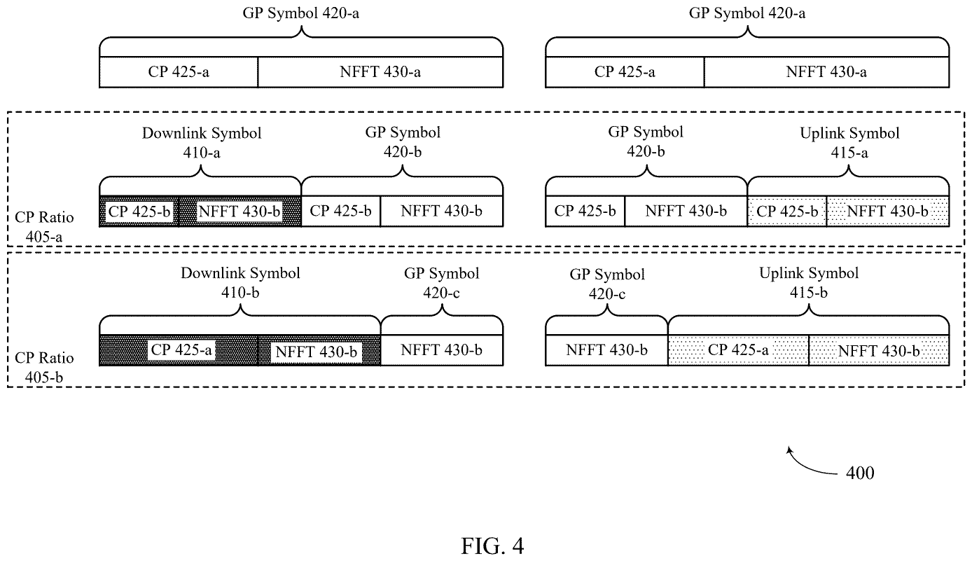

FIG. 4 shows an example of a symbol diagram 400 that supports techniques for mixed numerology slot formats in accordance with one or more aspects of the present disclosure. In some cases, the symbol diagram 400 may implement, or may be implemented by, aspects of the wireless communications system 100, the wireless communications system 200, the slot formats 300, or any combination thereof. For example, the symbol diagram 400 may be implemented by one or more UEs 115 and one or more network entities 105, which may be examples of the corresponding devices as described herein.

In some cases, to enable a first subset of symbols of a slot to be associated with a different numerology (e.g., SCS) than a second subset of symbols of the slot, both the first subset of symbols and the second subset of symbols may be associated with a same CP (e.g., a same cumulative length of a CP, a CP 425-a). That is, the first subset of symbols of the slot may be associated with a first numerology (e.g., smaller numerology) and a CP, and the second subset of symbols of the slot may be associated with a second numerology (e.g., a larger numerology) and the CP, where the first numerology is different than the second numerology. In some cases, the second numerology may be greater than the first numerology, such that a first symbol duration of each symbol in the first subset of symbols is greater than a second symbol duration of each symbol in the second subset of symbols. Thus, a CP ratio (e.g., a CP ratio 405-a associated with each symbol in the first subset of symbols (e.g., 7%) may be less than a CP ratio (e.g., a CP ratio 405-b) associated with each symbol in the second subset of symbols (e.g., 14%) due to the first symbol duration and the second symbol duration being different (e.g., but using the same CP 425).

For example, for a slot format associated with a uniform (e.g., a same) numerology, such as the slot format 300-a as described with reference to FIG. 3, a guard period may include a guard period symbol 420-a associated with a first numerology (e.g., a first SCS). In such cases, the guard period symbol 420-a may additionally be associated with (e.g., include) a CP 425-a and a non-uniform Fast Fourier Transform (NFFT) 430-a size. However, for a slot format associated with mixed (e.g., different) numerologies, such as the slot format 300-b and the slot format 300-c as described with reference to FIG. 3, the guard period may include a guard period symbol 420 associated with a second numerology (e.g., a second SCS) different from the first numerology, such as a guard period symbol 420-b or a guard period symbol 420-c.

For example, (e.g., in accordance with the slot format 300-b), for a CP ratio 405-a (e.g., a normal CP ratio 405), the second subset of symbols of the slot may include a downlink symbol 410-a and the guard period symbol 420-b, where both of the downlink symbol 410-a and the guard period symbol 420-b are associated with a CP 425-b (e.g., a same CP 425) and an NFFT 430-b (e.g., a same NFFT 430). In another example (e.g., in accordance with the slot format 300-b), for a CP ratio 405-b (e.g., an extended CP ratio 405), the second subset of symbols of the slot may include a downlink symbol 410-b and the guard period symbol 420-c, where both of the downlink symbol 410-b and the guard period symbol 420-c are associated with the NFFT 430-b and the downlink symbol 410-b is associated with a CP 425-a.

Similarly (e.g., in accordance with the slot format 300-c), for the CP ratio 405-a, the second subset of symbols of the slot may include an uplink symbol 415-a and the guard period symbol 420-b, where both of the uplink symbol 415-a and the guard period symbol 420-b are associated with the CP 425-b and the NFFT 430-b. In another example (e.g., in accordance with the slot format 300-c), for the CP ratio 405-b, the second subset of symbols of the slot may include an uplink symbol 415-b and the guard period symbol 420-c, where both of the uplink symbol 415-b and the guard period symbol 420-c are associated with the NFFT 430-b and the uplink symbol 415-b is associated with the CP 425-a.

In some cases, a length (e.g., duration) of the guard period symbol 420-a may be twice a length of the guard period symbol (e.g., a guard period symbol 420-b, a guard period symbol 420-c) associated with a second numerology. For example, the length of the guard period symbol 420-a, GPSymLen, may be calculated according to the following Equation 1, when the second subset of symbols of the slot include a downlink symbol (e.g., the downlink symbol 410-a) and a guard period symbol (e.g., the guard period 420-b), or the following Equation 2, when the second subset of symbols of the slot include an uplink symbol (e.g., the uplink symbol 415-a) and a guard period symbol (e.g., the guard period 420-b):

$$G {P}_{SymLen} = \frac{G {P}_{SymLen}}{2} + \frac{D {L}_{SymLen}}{2} \qquad ( 1 )$$

$$G {P}_{SymLen} = \frac{G {P}_{SymLen}}{2} + \frac{U {L}_{SymLen}}{2} \qquad ( 2 )$$

where

$$\frac{{GP}_{SymLen}}{2}$$

represents a length of the guard period symbol associated with the second numerology, and where DL_{SymLen} represents a length of a downlink symbol associated with the first numerology, such that

$$\frac{{DL}_{SymLen}}{2}$$

represents a length of a downlink symbol associated with the second numerology. Similarly, UL_{SymLen} represents a length of an uplink symbol associated with the first numerology, such that

$$\frac{{UL}_{SymLen}}{2}$$

represents a length of an uplink symbol associated with the second numerology.

Additionally, or alternatively, the UE 115 may use the downlink symbol 410-a, the downlink symbol 410-b, the uplink symbol 415-a, the uplink symbol 415-b, or any combination thereof (e.g., a shorter symbol) based on a data being associated with a TB size exceeding a threshold TB size, based on the data being associated with a lower code rate (e.g., same TB size and a higher code protection), based on one or more types of pilots, based on front loaded DMRS (e.g., even though the DMRS is decimated in full-duplex, in addition to regular DMRS), based on a calibration procedure, based on non-scheduling DCI signaling, or any combination thereof.

As described herein, the first numerology may be associated with a first SCS and the second numerology may be associated with a second SCS. Additionally, in some cases, such as when the second numerology is greater than the first numerology, the second SCS may be greater than the first SCS. However, using a larger SCS may result in performance degradations for channels associated with a delay spread exceeding a threshold delay spread (e.g., a large delay spread). Thus, using symbols associated with the second symbol duration (e.g., shorter symbols than symbols associated with the first numerology) may result in performance degradation unless a UE 115 uses a lower target signal-to-noise ratio (SNR), a lower target modulation and coding scheme (MCS), or both (e.g., as compared to longer symbols). As such, the UE 115 may use (e.g., support) a mixed numerology slot format (e.g., the slot format 300-b, the slot format 300-c) based on the UE 115 communicating via a channel associated with a DS satisfying (e.g., being less than or equal to) a threshold DS (e.g., low DS channel), based on the UE 115 communicating in accordance with an MCS satisfying (e.g., being less than or equal to) a threshold MCS (e.g., low MCS), or both. Conversely, the UE 115 may refrain from using the mixed numerology slot format (e.g., the slot format 300-b, the slot format 300-c) based on the UE 115 communicating via a channel associated with a DS failing to satisfy (e.g., being greater than) the threshold DS (e.g., high DS channel), based on the UE 115 communicating in accordance with an MCS satisfying (e.g., being greater than) the threshold MCS (e.g., high MCS), or both. Additionally, or alternatively, the UE 115 may support (e.g., be configured with) a set of dedicated transport blocks (TBs) that are capable of utilizing the additional resources (e.g., the downlink symbol 410-a, the downlink symbol 410-b, the uplink symbol 415-a, the uplink symbol 415-b).

By support guard period symbols 220 associated with the second numerology (e.g., the guard period symbol 420-b and the guard period symbol 420-c), a UE 115 may be capable of using the downlink symbol 410-a, the downlink symbol 410-b, the uplink symbol 415-a, the uplink symbol 415-b, or any combination thereof (e.g., additional resources) to increase throughput, achieve a higher reliability, decrease latency (e.g., of uplink), or any combination thereof (e.g., as compared to slots associated with the slot format 300-a).

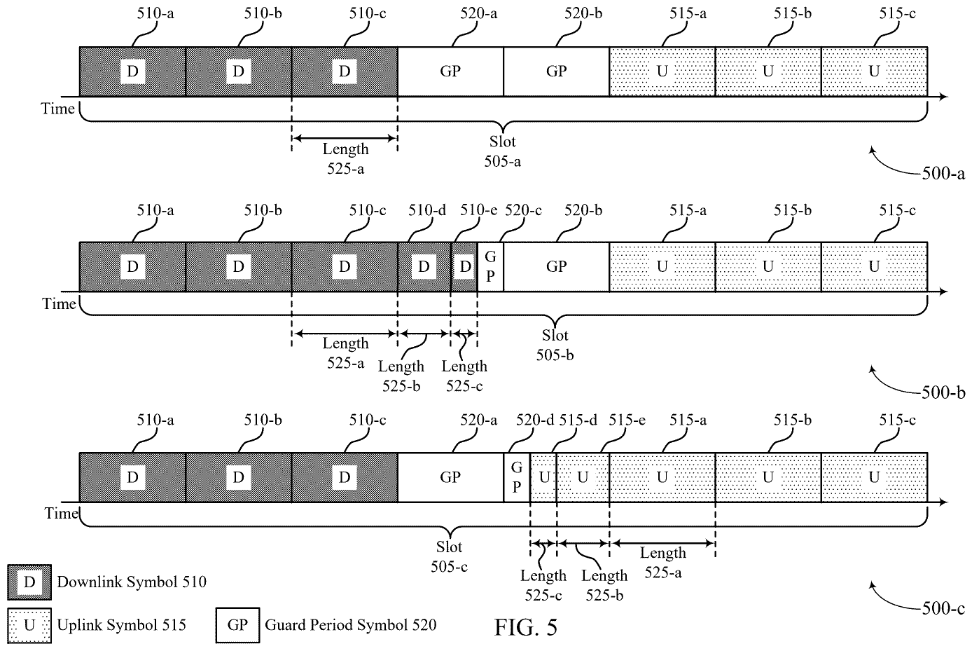

FIG. 5 shows examples of slot formats 500 (e.g., a slot format 500-a, a slot format 500-b, and a slot format 500-c) that support techniques for mixed numerology slot formats in accordance with one or more aspects of the present disclosure. In some cases, the slot formats 500 may be implemented by aspects of the wireless communications system 100, the wireless communications system 200, the slot formats 300, the symbol diagram 400, or any combination thereof. For example, the slot formats 500 may include one or more UEs 115 (e.g., a UE 115-a) and one or more network entities 105 (e.g., a network entity 105-a), which may be examples of the corresponding devices as described herein.

As described herein, some slot formats 500, such as a slot format 500-a, may support a single numerology. For example, in accordance with the slot format 500-a, a slot 505-a may include a downlink symbol 510-a, a downlink symbol 510-b, a downlink symbol 510-c, a guard period symbol 520-a, a guard period symbol 520-b, an uplink symbol 515-a, an uplink symbol 515-b, and an uplink symbol 515-c, where each downlink symbol 510, each uplink symbol 515, and each guard period symbol 520 may be associated with a same numerology (e.g., μ=N for the slot 505-a), such that each downlink symbol 510, each uplink symbol 515, and each guard period symbol 520 may be associated with a same length 525-a (e.g., duration). However, as described herein, using the same numerology for all symbols in a slot 505 may result in inefficient resource utilization.

As such, wireless devices, such as a UE 115 and a network entity 105, may support mixed numerology slot formats 500 associated with two different numerologies (e.g., μ=N, N+1), such as the slot format 300-b and the slot format 300-c, as described with reference to FIG. 3. Additionally, or alternatively, the wireless devices may support mixed numerology slot formats 500 associated with more than two different numerologies (e.g., μ=N, N+1, N+2), such as the slot format 500-b and the slot format 500-c (e.g., enabling only ¼ throughput loss due to a guard period).

For example, in accordance with the slot format 500-b, a slot 505-b may include the downlink symbol 510-a, the downlink symbol 510-b, the downlink symbol 510-c, a downlink symbol 510-d, a downlink symbol 510-e, a guard period symbol 520-c, the guard period symbol 520-b, the uplink symbol 515-a, the uplink symbol 515-b, and the uplink symbol 515-c. In such cases, the downlink symbol 510-a, the downlink symbol 510-b, the downlink symbol 510-c, the guard period symbol 520-b, the uplink symbol 515-a, the uplink symbol 515-b, and the uplink symbol 515-c may be associated with a first numerology (e.g., μ=N), the downlink symbol 510-d may be associated with a second numerology (e.g., μ=N+1), and both the downlink symbol 510-e and the guard period symbol 520-c may be associated with a third numerology (e.g., μ=N+2), where the first numerology, the second numerology, and the third numerology are different. Thus, the downlink symbol 510-d may be associated with a length 525-b, both the downlink symbol 510-e and the guard period symbol 520-c may be associated with a length 525-c, and remaining symbols of the slot 505-b may be associated with the length 525-a, where the length 525-c is shorter than the length 525-b, which is shorter than the length 525-a (e.g., based on the third numerology being greater than the second numerology, which is greater than the first numerology).

In another example, in accordance with the slot format 500-c, a slot 505-c may include the downlink symbol 510-a, the downlink symbol 510-b, the downlink symbol 510-c, the guard period symbol 520-a, a guard period symbol 520-d, an uplink symbol 515-d, an uplink symbol 515-e, the uplink symbol 515-a, the uplink symbol 515-b, and the uplink symbol 515-c. In such cases, the downlink symbol 510-a, the downlink symbol 510-b, the downlink symbol 510-c, the guard period symbol 520-a, the uplink symbol 515-a, the uplink symbol 515-b, and the uplink symbol 515-c may be associated with the first numerology (e.g., μ=N), the uplink symbol 515-e may be associated with the second numerology (e.g., μ=N+1), and both the guard period symbol 520-d and the uplink symbol 515-d may be associated with the third numerology (e.g., μ=N+2). Thus, the uplink symbol 515-e may be associated with the length 525-b, both the uplink symbol 515-d and the guard period symbol 520-d may be associated with the length 525-c, and remaining symbols of the slot 505-c may be associated with the length 525-a, where the length 525-c is shorter than the length 525-b, which is shorter than the length 525-a (e.g., based on the third numerology being greater than the second numerology, which is greater than the first numerology).

In some cases, additional IEs, different IEs, or both, in TDD-UL-DL-Pattern may be supported to enable switching between the slot format 500-a, the slot format 500-b, the slot format 500-c, the slot format 300-b, the slot format 300-c, or any combination thereof, as described with reference to FIG. 3

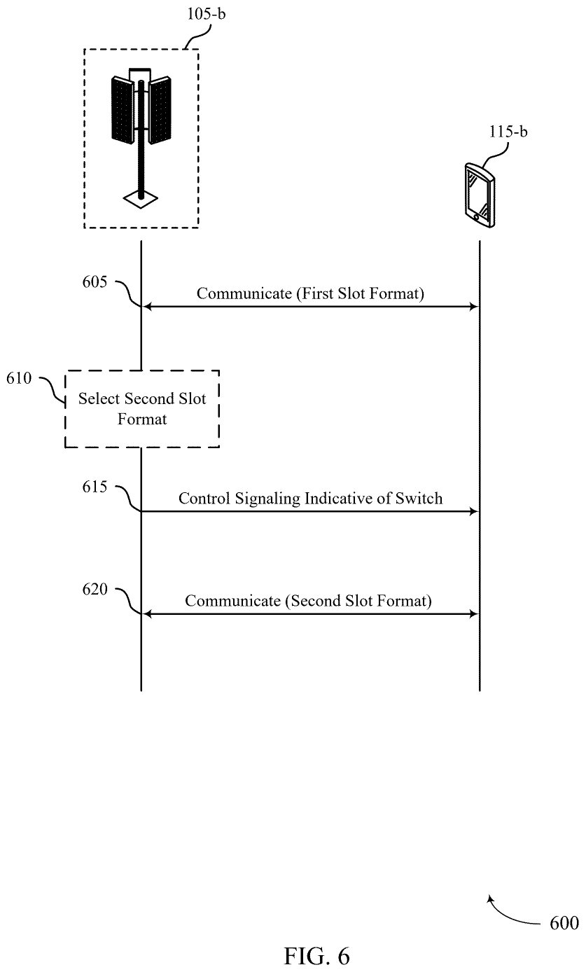

FIG. 6 shows an example of a process flow 600 that supports techniques for mixed numerology slot formats in accordance with one or more aspects of the present disclosure. In some cases, the process flow 600 may implement or be implemented by aspects of the wireless communications system 100, the wireless communications system 200, the slot formats 300, the symbol diagram 400, the slot formats 500, or any combination thereof. For example, the process flow 600 may include one or more UEs 115 (e.g., a UE 115-b) and one or more network entities 105 (e.g., a network entity 105-b), which may be examples of the corresponding devices as described herein. In the following description of the process flow 600, the operations between the UE 115-b and the network entity 105-b may be communicated in a different order than the example order shown, or the operations performed by the UE 115-b and the network entity 105-b may be performed in different orders or at different times. Some operations may also be omitted from the process flow 600, and other operations may be added to the process flow 600.

At signaling operation 605, the UE 115-b and the network entity 105-b may communicate (e.g., transmit, receive) during a first slot in accordance with a first slot format. In accordance with the first slot format, each symbol of the first slot may be associated with a first symbol numerology (e.g., μ=N) corresponding to a first SCS.

In some cases, at processing operation 610, the network entity 105-b may select a second slot format based on communicating via a channel associated with a DS satisfying a threshold DS, based on communicating in accordance with an MCS satisfying a threshold MCS, based on a nominal OH associated with the UE 115-b (e.g., exceeding a threshold nominal OH), based on traffic to be communicated by the network entity 105-b, based on a quantity of layers associated with the UE 115-b, or any combination thereof.

At signaling operation 615, the UE 115-b may receive control signaling indicative of a switch from the first slot format to the second slot format. In some cases, the control signaling may include an RRC message, such that the switch from the first slot format to the second slot format is indicated based on one or more IEs of the RRC message indicating the second slot format, the second symbol numerology, or both. For example, the one or more IEs may include a first IE (e.g., shortDownlinkSymbolEn) that indicates that the second subset of symbols includes one or more downlink symbols, a second IE (e.g., shortUplinkSymbolEn) that indicates that the second subset of symbols includes one or more uplink symbols, or both. Additionally, or alternatively, the control signaling may include a MAC-CE message, a DCI message, or both.

At signaling operation 620, the UE 115-b and the network entity 105-b may communicate (e.g., transmit, receive) during a second slot in accordance with the second slot format based on reception of the control signaling. In accordance with the second slot format, a first subset of symbols of the second slot may be associated with the first symbol numerology and a second subset of symbols of the second slot may be associated with a second symbol numerology (e.g., μ=N+1) corresponding to a second SCS, the second symbol numerology different from the first symbol numerology. In some examples, the second numerology may be greater than the first numerology, such that the second SCS is greater than the first SCS. For example, each symbol in the first subset of symbols may be associated with a first symbol duration and each symbol in the second subset of symbols may be associated with a second duration that is half of the first duration (e.g., based on the second numerology being greater than the first numerology).

In some cases, the second slot may include one or more downlink symbols, one or more uplink symbols, and a guard period between the one or more downlink symbols and the one or more uplink symbols in a time domain. In such cases, the guard period may include one or more symbols of the second subset of symbols associated with the second symbol numerology.

In some examples, the one or more symbols of the guard period in the second subset of symbols may include a first symbol within the guard period, and the second subset of symbols associated with the second symbol numerology may further include a last downlink symbol of the one or more downlink symbols that precedes the first symbol within the guard period in the time domain. Additionally, or alternatively, the one or more symbols of the guard period in the second subset of symbols may include a last symbol within the guard period, and the second subset of symbols associated with the second symbol numerology further includes a first uplink symbol of the one or more uplink symbols that follows the last symbol within the guard period in the time domain. Additionally, or alternatively, the guard period may include one or more symbols of the second subset of symbols associated with the second symbol numerology, and one or more additional symbols of the first subset of symbols associated with the first symbol numerology.

In some cases, in accordance with the second slot format, a third subset of symbols of the second slot may be associated with a third symbol numerology (e.g., μ=N+2), different from the first symbol numerology and the second symbol numerology. In such cases, the second slot may include one or more downlink symbols, one or more uplink symbols, and a guard period between the one or more downlink symbols and the one or more uplink symbols in the time domain, and the guard period may include one or more symbols of the third subset of symbols associated with the third symbol numerology.

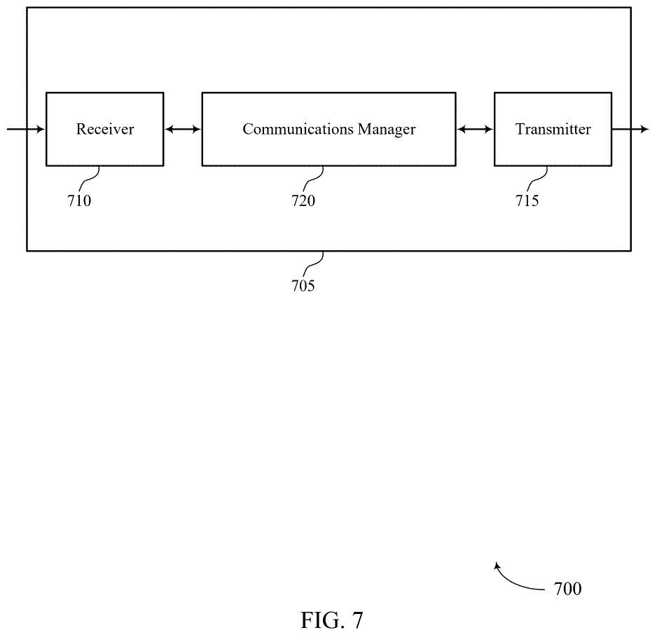

FIG. 7 shows a block diagram 700 of a device 705 that supports techniques for mixed numerology slot formats in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for mixed numerology slot formats). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for mixed numerology slot formats). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of techniques for mixed numerology slot formats as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for communicating during a first slot in accordance with a first slot format, where, in accordance with the first slot format, each symbol of the first slot is associated with a first symbol numerology corresponding to a first SCS. The communications manager 720 is capable of, configured to, or operable to support a means for receiving control signaling indicative of a switch from the first slot format to a second slot format. The communications manager 720 is capable of, configured to, or operable to support a means for communicating during a second slot in accordance with the second slot format based on reception of the control signaling, where, in accordance with the second slot format, a first subset of symbols of the second slot is associated with the first symbol numerology and a second subset of symbols of the second slot is associated with a second symbol numerology corresponding to a second SCS, and where the second symbol numerology is different from the first symbol numerology.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for mixed numerology slot formats, which may result in reduced processing, reduced power consumption, more efficient utilization of communication resources, among other advantages.

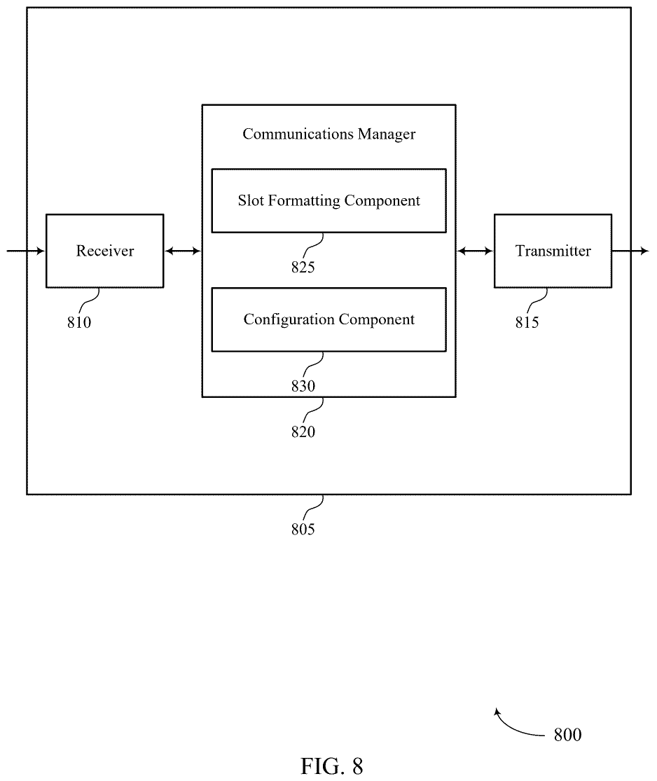

FIG. 8 shows a block diagram 800 of a device 805 that supports techniques for mixed numerology slot formats in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for mixed numerology slot formats). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for mixed numerology slot formats). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for mixed numerology slot formats as described herein. For example, the communications manager 820 may include a slot formatting component 825 a configuration component 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The slot formatting component 825 is capable of, configured to, or operable to support a means for communicating during a first slot in accordance with a first slot format, where, in accordance with the first slot format, each symbol of the first slot is associated with a first symbol numerology corresponding to a first SCS. The configuration component 830 is capable of, configured to, or operable to support a means for receiving control signaling indicative of a switch from the first slot format to a second slot format. The slot formatting component 825 is capable of, configured to, or operable to support a means for communicating during a second slot in accordance with the second slot format based on reception of the control signaling, where, in accordance with the second slot format, a first subset of symbols of the second slot is associated with the first symbol numerology and a second subset of symbols of the second slot is associated with a second symbol numerology corresponding to a second SCS, and where the second symbol numerology is different from the first symbol numerology.

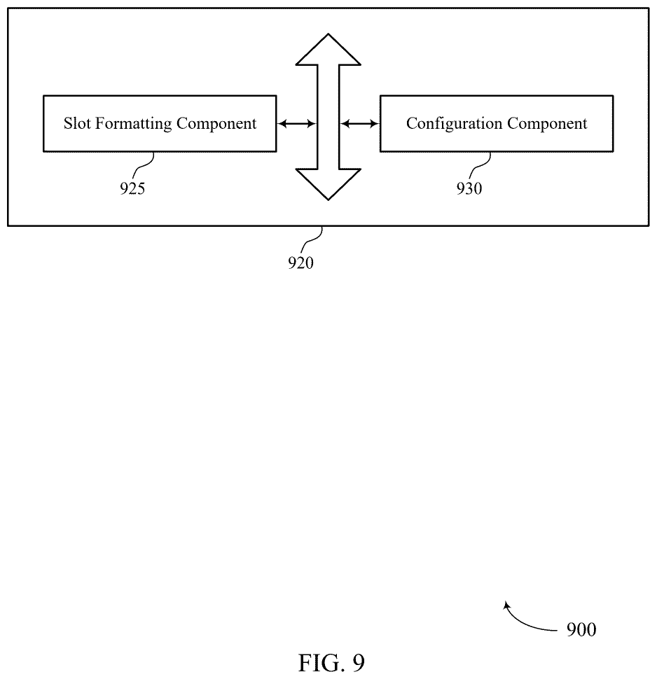

FIG. 9 shows a block diagram 900 of a communications manager 920 that supports techniques for mixed numerology slot formats in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for mixed numerology slot formats as described herein. For example, the communications manager 920 may include a slot formatting component 925 a configuration component 930, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The slot formatting component 925 is capable of, configured to, or operable to support a means for communicating during a first slot in accordance with a first slot format, where, in accordance with the first slot format, each symbol of the first slot is associated with a first symbol numerology corresponding to a first SCS. The configuration component 930 is capable of, configured to, or operable to support a means for receiving control signaling indicative of a switch from the first slot format to a second slot format. In some examples, the slot formatting component 925 is capable of, configured to, or operable to support a means for communicating during a second slot in accordance with the second slot format based on reception of the control signaling, where, in accordance with the second slot format, a first subset of symbols of the second slot is associated with the first symbol numerology and a second subset of symbols of the second slot is associated with a second symbol numerology corresponding to a second SCS, and where the second symbol numerology is different from the first symbol numerology.

In some examples, the second slot includes one or more downlink symbols, one or more uplink symbols, and a guard period between the one or more downlink symbols and the one or more uplink symbols in a time domain. In some examples, the guard period includes one or more symbols of the second subset of symbols associated with the second symbol numerology.

In some examples, the one or more symbols of the guard period in the second subset of symbols include a first symbol within the guard period. In some examples, the second subset of symbols associated with the second symbol numerology further include a last downlink symbol of the one or more downlink symbols that precedes the first symbol within the guard period in the time domain.

In some examples, the one or more symbols of the guard period in the second subset of symbols include a last symbol within the guard period. In some examples, the second subset of symbols associated with the second symbol numerology further include a first uplink symbol of the one or more uplink symbols that follows the last symbol within the guard period in the time domain.

In some examples, the guard period includes the one or more symbols of the second subset of symbols associated with the second symbol numerology, and one or more additional symbols of the first subset of symbols associated with the first symbol numerology.

In some examples, communicating in accordance with the second slot format is based on the UE communicating via a channel associated with a delay spread satisfying a threshold delay spread, based on the UE communicating in accordance with an MCS satisfying a threshold MCS, based on a nominal overhead associated with the UE, based on traffic to be communicated by the UE, based on a quantity of layers associated with the UE, or any combination thereof.

In some examples, in accordance with the second slot format, a third subset of symbols of the second slot is associated with a third symbol numerology, different from the first symbol numerology and the second symbol numerology.

In some examples, the second slot includes one or more downlink symbols, one or more uplink symbols, and a guard period between the one or more downlink symbols and the one or more uplink symbols in a time domain, and. In some examples, the guard period includes one or more symbols of the third subset of symbols associated with the third symbol numerology.

In some examples, the control signaling includes an RRC message. In some examples, the switch from the first slot format to the second slot format is indicated based on one or more IEs of the RRC message indicating the second slot format, the second symbol numerology, or both.

In some examples, the one or more IEs includes a first IE that indicates that the second subset of symbols includes one or more downlink symbols, a second IE that indicates that the second subset of symbols includes one or more uplink symbols, or both.

In some examples, the control signaling includes MAC-CE message, a DCI message, or both.

In some examples, the second symbol numerology is greater than the first symbol numerology. In some examples, the second SCS is greater than the first SCS based on the second symbol numerology being greater than the first symbol numerology.

In some examples, each symbol in the first subset of symbols is associated with a first duration. In some examples, each symbol in the second subset of symbols is associated with a second duration that is half of the first duration.

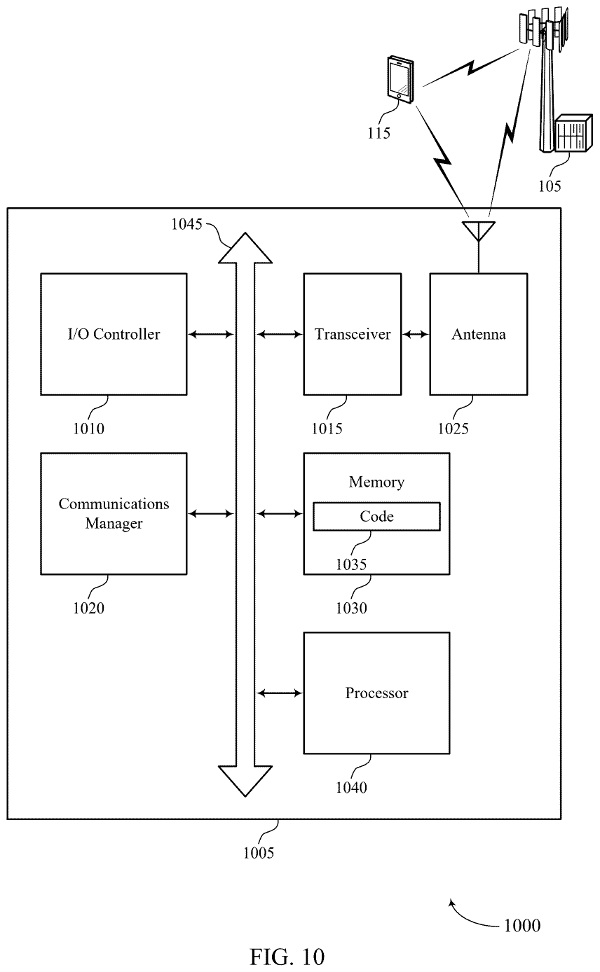

FIG. 10 shows a diagram of a system 1000 including a device 1005 that supports techniques for mixed numerology slot formats in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting techniques for mixed numerology slot formats). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for communicating during a first slot in accordance with a first slot format, where, in accordance with the first slot format, each symbol of the first slot is associated with a first symbol numerology corresponding to a first SCS. The communications manager 1020 is capable of, configured to, or operable to support a means for receiving control signaling indicative of a switch from the first slot format to a second slot format. The communications manager 1020 is capable of, configured to, or operable to support a means for communicating during a second slot in accordance with the second slot format based on reception of the control signaling, where, in accordance with the second slot format, a first subset of symbols of the second slot is associated with the first symbol numerology and a second subset of symbols of the second slot is associated with a second symbol numerology corresponding to a second SCS, and where the second symbol numerology is different from the first symbol numerology.

By including or configuring the communications manager 1020 in accordance with examples as described herein, the device 1005 may support techniques for mixed numerology slot formats, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of techniques for mixed numerology slot formats as described herein, or the at least one processor 1040 and the at least one memory 1030 may be otherwise configured to, individually or collectively, perform or support such operations.

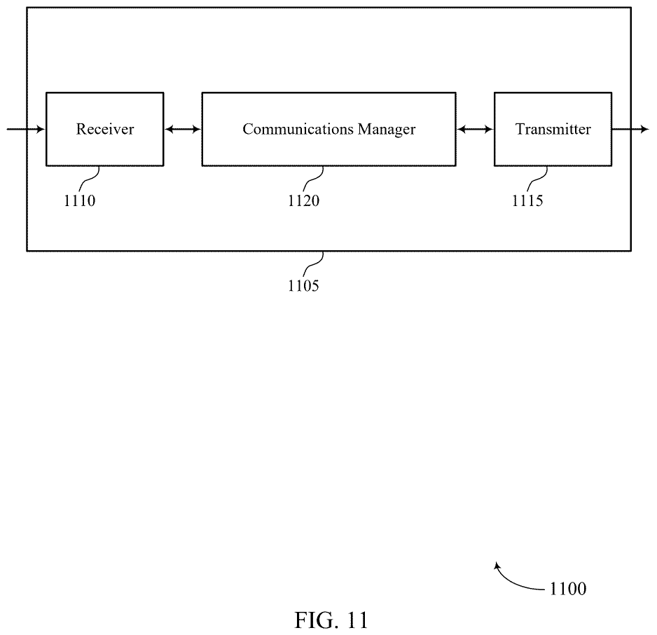

FIG. 11 shows a block diagram 1100 of a device 1105 that supports techniques for mixed numerology slot formats in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of techniques for mixed numerology slot formats as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for communicating during a first slot in accordance with a first slot format, where, in accordance with the first slot format, each symbol of the first slot is associated with a first symbol numerology corresponding to a first SCS. The communications manager 1120 is capable of, configured to, or operable to support a means for transmitting control signaling indicative of a switch from the first slot format to a second slot format. The communications manager 1120 is capable of, configured to, or operable to support a means for communicating during a second slot in accordance with the second slot format based on transmission of the control signaling, where, in accordance with the second slot format, a first subset of symbols of the second slot is associated with the first symbol numerology and a second subset of symbols of the second slot is associated with a second symbol numerology corresponding to a second SCS, and where the second symbol numerology is different from the first symbol numerology.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for mixed numerology slot formats, which may result in reduced processing, reduced power consumption, and more efficient utilization of communication resources, among other advantages.

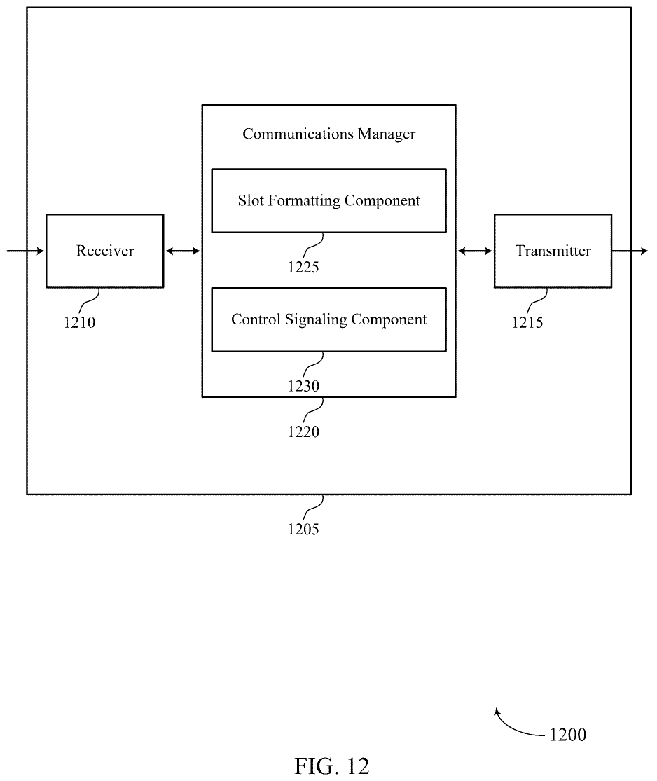

FIG. 12 shows a block diagram 1200 of a device 1205 that supports techniques for mixed numerology slot formats in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for mixed numerology slot formats as described herein. For example, the communications manager 1220 may include a slot formatting component 1225 a control signaling component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The slot formatting component 1225 is capable of, configured to, or operable to support a means for communicating during a first slot in accordance with a first slot format, where, in accordance with the first slot format, each symbol of the first slot is associated with a first symbol numerology corresponding to a first SCS. The control signaling component 1230 is capable of, configured to, or operable to support a means for transmitting control signaling indicative of a switch from the first slot format to a second slot format. The slot formatting component 1225 is capable of, configured to, or operable to support a means for communicating during a second slot in accordance with the second slot format based on transmission of the control signaling, where, in accordance with the second slot format, a first subset of symbols of the second slot is associated with the first symbol numerology and a second subset of symbols of the second slot is associated with a second symbol numerology corresponding to a second SCS, and where the second symbol numerology is different from the first symbol numerology.

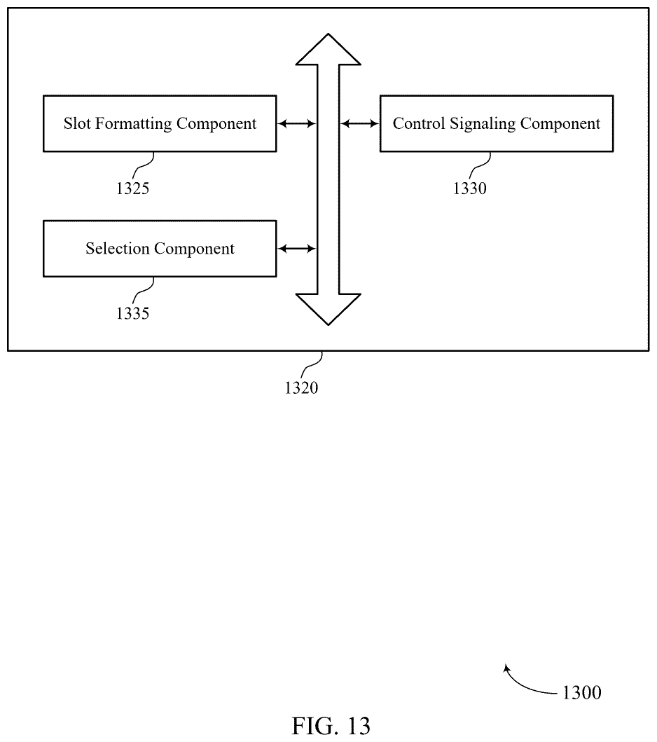

FIG. 13 shows a block diagram 1300 of a communications manager 1320 that supports techniques for mixed numerology slot formats in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for mixed numerology slot formats as described herein. For example, the communications manager 1320 may include a slot formatting component 1325, a control signaling component 1330, a selection component 1335, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The slot formatting component 1325 is capable of, configured to, or operable to support a means for communicating during a first slot in accordance with a first slot format, where, in accordance with the first slot format, each symbol of the first slot is associated with a first symbol numerology corresponding to a first SCS. The control signaling component 1330 is capable of, configured to, or operable to support a means for transmitting control signaling indicative of a switch from the first slot format to a second slot format. In some examples, the slot formatting component 1325 is capable of, configured to, or operable to support a means for communicating during a second slot in accordance with the second slot format based on transmission of the control signaling, where, in accordance with the second slot format, a first subset of symbols of the second slot is associated with the first symbol numerology and a second subset of symbols of the second slot is associated with a second symbol numerology corresponding to a second SCS, and where the second symbol numerology is different from the first symbol numerology.

In some examples, the second slot includes one or more downlink symbols, one or more uplink symbols, and a guard period between the one or more downlink symbols and the one or more uplink symbols in a time domain. In some examples, the guard period includes one or more symbols of the second subset of symbols associated with the second symbol numerology.

In some examples, the one or more symbols of the guard period in the second subset of symbols include a first symbol within the guard period. In some examples, the second subset of symbols associated with the second symbol numerology further include a last downlink symbol of the one or more downlink symbols that precedes the first symbol within the guard period in the time domain.

In some examples, the one or more symbols of the guard period in the second subset of symbols include a last symbol within the guard period. In some examples, the second subset of symbols associated with the second symbol numerology further include a first uplink symbol of the one or more uplink symbols that follows the last symbol within the guard period in the time domain.

In some examples, the guard period includes the one or more symbols of the second subset of symbols associated with the second symbol numerology, and one or more additional symbols of the first subset of symbols associated with the first symbol numerology.

In some examples, the selection component 1335 is capable of, configured to, or operable to support a means for selecting the second slot format based on communicating via a channel associated with a delay spread satisfying a threshold delay spread, based on communicating in accordance with an MCS satisfying a threshold MCS, based on a nominal overhead associated with a UE, based on traffic to be communicated by the network entity, based on a quantity of layers associated with the UE, or any combination thereof.

In some examples, in accordance with the second slot format, a third subset of symbols of the second slot is associated with a third symbol numerology, different from the first symbol numerology and the second symbol numerology.

In some examples, the second slot includes one or more downlink symbols, one or more uplink symbols, and a guard period between the one or more downlink symbols and the one or more uplink symbols in a time domain, and. In some examples, the guard period includes one or more symbols of the third subset of symbols associated with the third symbol numerology.

In some examples, the control signaling includes an RRC message. In some examples, the switch from the first slot format to the second slot format is indicated based on one or more IEs of the RRC message indicating the second slot format, the second symbol numerology, or both.

In some examples, the one or more IEs includes a first IE that indicates that the second subset of symbols includes one or more downlink symbols, a second IE that indicates that the second subset of symbols includes one or more uplink symbols, or both.

In some examples, the control signaling includes MAC-CE message, a DCI message, or both.

In some examples, the second symbol numerology is greater than the first symbol numerology. In some examples, the second SCS is greater than the first SCS based on the second symbol numerology being greater than the first symbol numerology.

In some examples, each symbol in the first subset of symbols is associated with a first duration. In some examples, each symbol in the second subset of symbols is associated with a second duration that is half of the first duration.

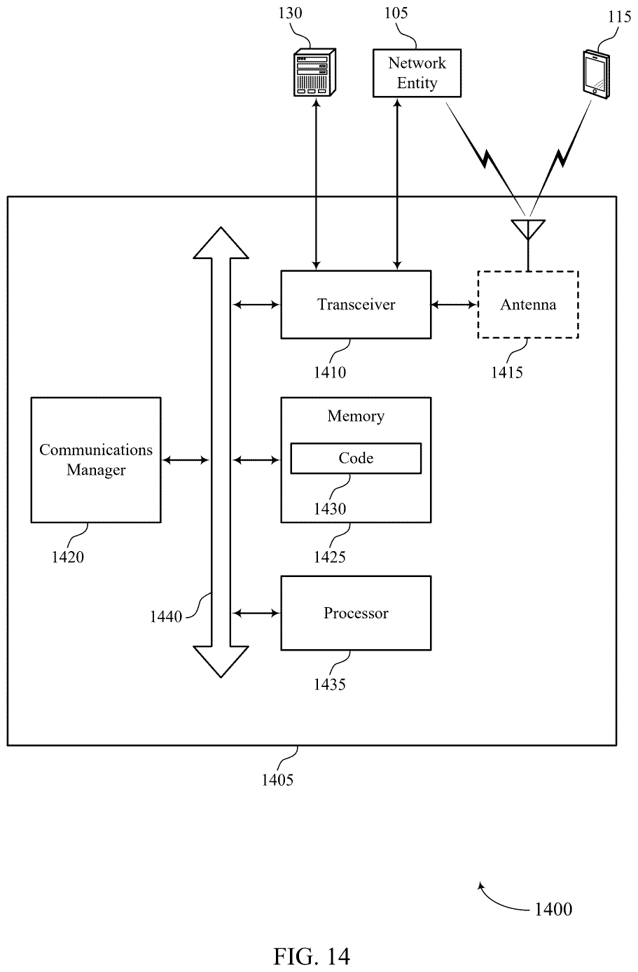

FIG. 14 shows a diagram of a system 1400 including a device 1405 that supports techniques for mixed numerology slot formats in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting techniques for mixed numerology slot formats). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for communicating during a first slot in accordance with a first slot format, where, in accordance with the first slot format, each symbol of the first slot is associated with a first symbol numerology corresponding to a first SCS. The communications manager 1420 is capable of, configured to, or operable to support a means for transmitting control signaling indicative of a switch from the first slot format to a second slot format. The communications manager 1420 is capable of, configured to, or operable to support a means for communicating during a second slot in accordance with the second slot format based on transmission of the control signaling, where, in accordance with the second slot format, a first subset of symbols of the second slot is associated with the first symbol numerology and a second subset of symbols of the second slot is associated with a second symbol numerology corresponding to a second SCS, and where the second symbol numerology is different from the first symbol numerology.

By including or configuring the communications manager 1420 in accordance with examples as described herein, the device 1405 may support techniques for mixed numerology slot formats, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of techniques for mixed numerology slot formats as described herein, or the at least one processor 1435 and the at least one memory 1425 may be otherwise configured to, individually or collectively, perform or support such operations.

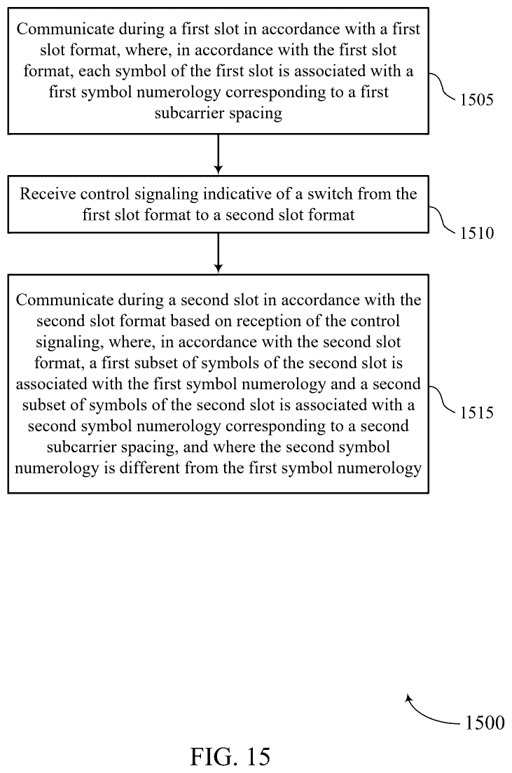

FIG. 15 shows a flowchart illustrating a method 1500 that supports techniques for mixed numerology slot formats in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include communicating during a first slot in accordance with a first slot format, where, in accordance with the first slot format, each symbol of the first slot is associated with a first symbol numerology corresponding to a first SCS. The operations of 1505 may be performed in accordance with examples as disclosed herein. In some examples, aspects of the operations of 1505 may be performed by a slot formatting component 925 as described with reference to FIG. 9.

At 1510, the method may include receiving control signaling indicative of a switch from the first slot format to a second slot format. The operations of 1510 may be performed in accordance with examples as disclosed herein. In some examples, aspects of the operations of 1510 may be performed by a configuration component 930 as described with reference to FIG. 9.

At 1515, the method may include communicating during a second slot in accordance with the second slot format based on reception of the control signaling, where, in accordance with the second slot format, a first subset of symbols of the second slot is associated with the first symbol numerology and a second subset of symbols of the second slot is associated with a second symbol numerology corresponding to a second SCS, and where the second symbol numerology is different from the first symbol numerology. The operations of 1515 may be performed in accordance with examples as disclosed herein. In some examples, aspects of the operations of 1515 may be performed by a slot formatting component 925 as described with reference to FIG. 9.

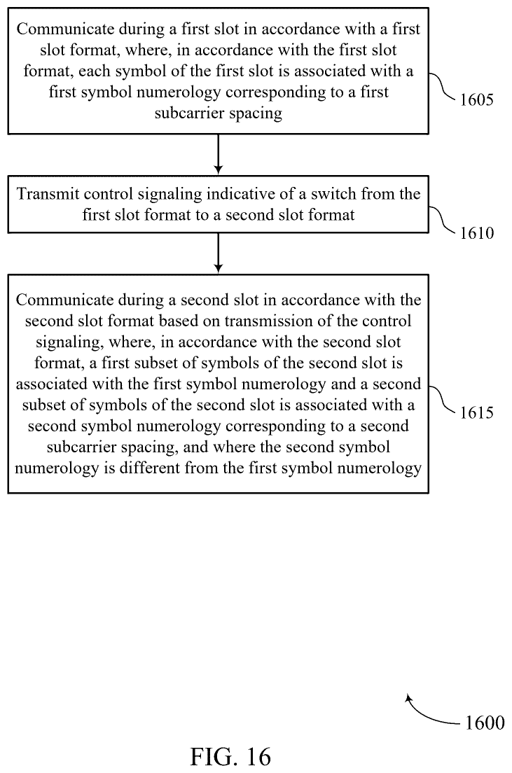

FIG. 16 shows a flowchart illustrating a method 1600 that supports techniques for mixed numerology slot formats in accordance with one or more aspects of the present disclosure. The operations of the method 1600 may be implemented by a network entity or its components as described herein. For example, the operations of the method 1600 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include communicating during a first slot in accordance with a first slot format, where, in accordance with the first slot format, each symbol of the first slot is associated with a first symbol numerology corresponding to a first SCS. The operations of 1605 may be performed in accordance with examples as disclosed herein. In some examples, aspects of the operations of 1605 may be performed by a slot formatting component 1325 as described with reference to FIG. 13.

At 1610, the method may include transmitting control signaling indicative of a switch from the first slot format to a second slot format. The operations of 1610 may be performed in accordance with examples as disclosed herein. In some examples, aspects of the operations of 1610 may be performed by a control signaling component 1330 as described with reference to FIG. 13.

At 1615, the method may include communicating during a second slot in accordance with the second slot format based on transmission of the control signaling, where, in accordance with the second slot format, a first subset of symbols of the second slot is associated with the first symbol numerology and a second subset of symbols of the second slot is associated with a second symbol numerology corresponding to a second SCS, and wherein the second symbol numerology is different from the first symbol numerology. The operations of 1615 may be performed in accordance with examples as disclosed herein. In some examples, aspects of the operations of 1615 may be performed by a slot formatting component 1325 as described with reference to FIG. 13.

The following provides an overview of aspects of the present disclosure:

Aspect 1: A method for wireless communications at a UE, comprising: communicating during a first slot in accordance with a first slot format, wherein, in accordance with the first slot format, each symbol of the first slot is associated with a first symbol numerology corresponding to a first SCS; receiving control signaling indicative of a switch from the first slot format to a second slot format; and communicating during a second slot in accordance with the second slot format based at least in part on reception of the control signaling, wherein, in accordance with the second slot format, a first subset of symbols of the second slot is associated with the first symbol numerology and a second subset of symbols of the second slot is associated with a second symbol numerology corresponding to a second SCS, and where the second symbol numerology is different from the first symbol numerology.

Aspect 2: The method of aspect 1, wherein the second slot comprises one or more downlink symbols, one or more uplink symbols, and a guard period between the one or more downlink symbols and the one or more uplink symbols in a time domain, and the guard period comprises one or more symbols of the second subset of symbols associated with the second symbol numerology.

Aspect 3: The method of aspect 2, wherein the one or more symbols of the guard period in the second subset of symbols comprise a first symbol within the guard period, and the second subset of symbols associated with the second symbol numerology further comprise a last downlink symbol of the one or more downlink symbols that precedes the first symbol within the guard period in the time domain.

Aspect 4: The method of any of aspects 2 through 3, wherein the one or more symbols of the guard period in the second subset of symbols comprise a last symbol within the guard period, and the second subset of symbols associated with the second symbol numerology further comprise a first uplink symbol of the one or more uplink symbols that follows the last symbol within the guard period in the time domain.

Aspect 5: The method of any of aspects 2 through 4, wherein the guard period comprises the one or more symbols of the second subset of symbols associated with the second symbol numerology, and one or more additional symbols of the first subset of symbols associated with the first symbol numerology.

Aspect 6: The method of any of aspects 1 through 5, wherein communicating in accordance with the second slot format is based at least in part on the UE communicating via a channel associated with a delay spread satisfying a threshold delay spread, based at least in part on the UE communicating in accordance with a MCS satisfying a threshold MCS, based at least in part on a nominal overhead associated with the UE, based at least in part on traffic to be communicated by the UE, based at least in part on a quantity of layers associated with the UE, or any combination thereof.

Aspect 7: The method of any of aspects 1 through 6, wherein in accordance with the second slot format, a third subset of symbols of the second slot is associated with a third symbol numerology, different from the first symbol numerology and the second symbol numerology.

Aspect 8: The method of aspect 7, wherein the second slot comprises one or more downlink symbols, one or more uplink symbols, and a guard period between the one or more downlink symbols and the one or more uplink symbols in a time domain, and the guard period comprises one or more symbols of the third subset of symbols associated with the third symbol numerology.

Aspect 9: The method of any of aspects 1 through 8, wherein the control signaling comprises a RRC message, and the switch from the first slot format to the second slot format is indicated based at least in part on one or more IEs of the RRC message indicating the second slot format, the second symbol numerology, or both.

Aspect 10: The method of aspect 9, wherein the one or more IEs comprises a first IE that indicates that the second subset of symbols comprises one or more downlink symbols, a second IE that indicates that the second subset of symbols comprises one or more uplink symbols, or both.

Aspect 11: The method of any of aspects 1 through 10, wherein the control signaling comprises medium access control-control element message, a downlink control information message, or both.

Aspect 12: The method of any of aspects 1 through 11, wherein the second symbol numerology is greater than the first symbol numerology, and the second SCS is greater than the first SCS based at least in part on the second symbol numerology being greater than the first symbol numerology.

Aspect 13: The method of aspect 12, wherein each symbol in the first subset of symbols is associated with a first duration, and each symbol in the second subset of symbols is associated with a second duration that is half of the first duration.

Aspect 14: A method for wireless communications at a network entity, comprising: communicating during a first slot in accordance with a first slot format, wherein, in accordance with the first slot format, each symbol of the first slot is associated with a first symbol numerology corresponding to a first SCS; transmitting control signaling indicative of a switch from the first slot format to a second slot format; and communicating during a second slot in accordance with the second slot format based at least in part on transmission of the control signaling, wherein, in accordance with the second slot format, a first subset of symbols of the second slot is associated with the first symbol numerology and a second subset of symbols of the second slot is associated with a second symbol numerology corresponding to a second SCS, and wherein the second symbol numerology is different from the first symbol numerology.

Aspect 15: The method of aspect 14, wherein the second slot comprises one or more downlink symbols, one or more uplink symbols, and a guard period between the one or more downlink symbols and the one or more uplink symbols in a time domain, and the guard period comprises one or more symbols of the second subset of symbols associated with the second symbol numerology.

Aspect 16: The method of aspect 15, wherein the one or more symbols of the guard period in the second subset of symbols comprise a first symbol within the guard period, and the second subset of symbols associated with the second symbol numerology further comprise a last downlink symbol of the one or more downlink symbols that precedes the first symbol within the guard period in the time domain.

Aspect 17: The method of any of aspects 15 through 16, wherein the one or more symbols of the guard period in the second subset of symbols comprise a last symbol within the guard period, and the second subset of symbols associated with the second symbol numerology further comprise a first uplink symbol of the one or more uplink symbols that follows the last symbol within the guard period in the time domain.

Aspect 18: The method of any of aspects 15 through 17, wherein the guard period comprises the one or more symbols of the second subset of symbols associated with the second symbol numerology, and one or more additional symbols of the first subset of symbols associated with the first symbol numerology.

Aspect 19: The method of any of aspects 14 through 18, further comprising: selecting the second slot format based at least in part on communicating via a channel associated with a delay spread satisfying a threshold delay spread, based at least in part on communicating in accordance with a MCS satisfying a threshold MCS, based at least in part on a nominal overhead associated with a UE, based at least in part on traffic to be communicated by the network entity, based at least in part on a quantity of layers associated with the UE, or any combination thereof.

Aspect 20: The method of any of aspects 14 through 19, wherein in accordance with the second slot format, a third subset of symbols of the second slot is associated with a third symbol numerology, different from the first symbol numerology and the second symbol numerology.

Aspect 21: The method of aspect 20, wherein the second slot comprises one or more downlink symbols, one or more uplink symbols, and a guard period between the one or more downlink symbols and the one or more uplink symbols in a time domain, and the guard period comprises one or more symbols of the third subset of symbols associated with the third symbol numerology.

Aspect 22: The method of any of aspects 14 through 21, wherein the control signaling comprises a RRC message, and the switch from the first slot format to the second slot format is indicated based at least in part on one or more IEs of the RRC message indicating the second slot format, the second symbol numerology, or both.

Aspect 23: The method of aspect 22, wherein the one or more IEs comprises a first IE that indicates that the second subset of symbols comprises one or more downlink symbols, a second IE that indicates that the second subset of symbols comprises one or more uplink symbols, or both.

Aspect 24: The method of any of aspects 14 through 23, wherein the control signaling comprises medium access control-control element message, a downlink control information message, or both.

Aspect 25: The method of any of aspects 14 through 24, wherein the second symbol numerology is greater than the first symbol numerology, and the second SCS is greater than the first SCS based at least in part on the second symbol numerology being greater than the first symbol numerology.

Aspect 26: The method of any of aspects 14 through 25, wherein each symbol in the first subset of symbols is associated with a first duration, and each symbol in the second subset of symbols is associated with a second duration that is half of the first duration.

Aspect 27: A UE for wireless communications, comprising one or more memories storing processor-executable code, and one or more processors coupled with the one or more memories and individually or collectively operable to execute the code to cause the UE to perform a method of any of aspects 1 through 13.

Aspect 28: A UE for wireless communications, comprising at least one means for performing a method of any of aspects 1 through 13.

Aspect 29: A non-transitory computer-readable medium storing code for wireless communications, the code comprising instructions executable by one or more processors to perform a method of any of aspects 1 through 13.

Aspect 30: A network entity for wireless communications, comprising one or more memories storing processor-executable code, and one or more processors coupled with the one or more memories and individually or collectively operable to execute the code to cause the network entity to perform a method of any of aspects 14 through 26.

Aspect 31: A network entity for wireless communications, comprising at least one means for performing a method of any of aspects 14 through 26.

Aspect 32: A non-transitory computer-readable medium storing code for wireless communications, the code comprising instructions executable by one or more processors to perform a method of any of aspects 14 through 26.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
communicate during a first slot in accordance with a first slot format, wherein, in accordance with the first slot format, each symbol of the first slot is associated with a first symbol numerology corresponding to a first subcarrier spacing;
receive control signaling indicative of a switch from the first slot format to a second slot format; and
communicate during a second slot in accordance with the second slot format based at least in part on reception of the control signaling, wherein, in accordance with the second slot format, a first subset of symbols of the second slot is associated with the first symbol numerology and a second subset of symbols of the second slot is associated with a second symbol numerology corresponding to a second subcarrier spacing, and wherein the second symbol numerology is different from the first symbol numerology.

2. The UE of claim 1, wherein the second slot comprises one or more downlink symbols, one or more uplink symbols, and a guard period between the one or more downlink symbols and the one or more uplink symbols in a time domain, and wherein the guard period comprises one or more symbols of the second subset of symbols associated with the second symbol numerology.

3. The UE of claim 2, wherein the one or more symbols of the guard period in the second subset of symbols comprise a first symbol within the guard period, and wherein the second subset of symbols associated with the second symbol numerology further comprise a last downlink symbol of the one or more downlink symbols that precedes the first symbol within the guard period in the time domain.

4. The UE of claim 2, wherein the one or more symbols of the guard period in the second subset of symbols comprise a last symbol within the guard period, and wherein the second subset of symbols associated with the second symbol numerology further comprise a first uplink symbol of the one or more uplink symbols that follows the last symbol within the guard period in the time domain.

5. The UE of claim 2, wherein the guard period comprises the one or more symbols of the second subset of symbols associated with the second symbol numerology, and one or more additional symbols of the first subset of symbols associated with the first symbol numerology.

6. The UE of claim 1, wherein communicating in accordance with the second slot format is based at least in part on the UE communicating via a channel associated with a delay spread satisfying a threshold delay spread, based at least in part on the UE communicating in accordance with a modulation and coding scheme satisfying a threshold modulation and coding scheme, based at least in part on a nominal overhead associated with the UE, based at least in part on traffic to be communicated by the UE, based at least in part on a quantity of layers associated with the UE, or any combination thereof.

7. The UE of claim 1, wherein in accordance with the second slot format, a third subset of symbols of the second slot is associated with a third symbol numerology, different from the first symbol numerology and the second symbol numerology.

8. The UE of claim 7, wherein the second slot comprises one or more downlink symbols, one or more uplink symbols, and a guard period between the one or more downlink symbols and the one or more uplink symbols in a time domain, and wherein the guard period comprises one or more symbols of the third subset of symbols associated with the third symbol numerology.

9. The UE of claim 1, wherein the control signaling comprises a radio resource control message, and wherein the switch from the first slot format to the second slot format is indicated based at least in part on one or more information elements of the radio resource control message indicating the second slot format, the second symbol numerology, or both.

10. The UE of claim 9, wherein the one or more information elements comprises a first information element that indicates that the second subset of symbols comprises one or more downlink symbols, a second information element that indicates that the second subset of symbols comprises one or more uplink symbols, or both.

11. The UE of claim 1, wherein the control signaling comprises a medium access control-control element message, a downlink control information message, or both.

12. The UE of claim 1, wherein the second symbol numerology is greater than the first symbol numerology, and wherein the second subcarrier spacing is greater than the first subcarrier spacing based at least in part on the second symbol numerology being greater than the first symbol numerology.

13. The UE of claim 12, wherein each symbol in the first subset of symbols is associated with a first duration, and wherein each symbol in the second subset of symbols is associated with a second duration that is half of the first duration.

14. A network entity, comprising:
one or more memories storing processor-executable code; and
one or more processors coupled with the one or more memories and individually or collectively operable to execute the code to cause the network entity to:
communicate during a first slot in accordance with a first slot format, wherein, in accordance with the first slot format, each symbol of the first slot is associated with a first symbol numerology corresponding to a first subcarrier spacing;
transmit control signaling indicative of a switch from the first slot format to a second slot format; and
communicate during a second slot in accordance with the second slot format based at least in part on transmission of the control signaling, wherein, in accordance with the second slot format, a first subset of symbols of the second slot is associated with the first symbol numerology and a second subset of symbols of the second slot is associated with a second symbol numerology corresponding to a second subcarrier spacing, and wherein the second symbol numerology is different from the first symbol numerology.

15. The network entity of claim 14, wherein the second slot comprises one or more downlink symbols, one or more uplink symbols, and a guard period between the one or more downlink symbols and the one or more uplink symbols in a time domain, and wherein the guard period comprises one or more symbols of the second subset of symbols associated with the second symbol numerology.

16. The network entity of claim 15, wherein the one or more symbols of the guard period in the second subset of symbols comprise a first symbol within the guard period, and wherein the second subset of symbols associated with the second symbol numerology further comprise a last downlink symbol of the one or more downlink symbols that precedes the first symbol within the guard period in the time domain.

17. The network entity of claim 15, wherein the one or more symbols of the guard period in the second subset of symbols comprise a last symbol within the guard period, and wherein the second subset of symbols associated with the second symbol numerology further comprise a first uplink symbol of the one or more uplink symbols that follows the last symbol within the guard period in the time domain.

18. The network entity of claim 15, wherein the guard period comprises the one or more symbols of the second subset of symbols associated with the second symbol numerology, and one or more additional symbols of the first subset of symbols associated with the first symbol numerology.

19. The network entity of claim 14, wherein the one or more processors are individually or collectively further operable to execute the code to cause the network entity to:
select the second slot format based at least in part on communicating via a channel associated with a delay spread satisfying a threshold delay spread, based at least in part on communicating in accordance with a modulation and coding scheme satisfying a threshold modulation and coding scheme, based at least in part on a nominal overhead associated with a user equipment (UE), based at least in part on traffic to be communicated by the network entity, based at least in part on a quantity of layers associated with the UE, or any combination thereof.

20. The network entity of claim 14, wherein in accordance with the second slot format, a third subset of symbols of the second slot is associated with a third symbol numerology, different from the first symbol numerology and the second symbol numerology.

21. The network entity of claim 20, wherein the second slot comprises one or more downlink symbols, one or more uplink symbols, and a guard period between the one or more downlink symbols and the one or more uplink symbols in a time domain, and wherein the guard period comprises one or more symbols of the third subset of symbols associated with the third symbol numerology.

22. The network entity of claim 14, wherein the control signaling comprises a radio resource control message, and wherein the switch from the first slot format to the second slot format is indicated based at least in part on one or more information elements of the radio resource control message indicating the second slot format, the second symbol numerology, or both.

23. The network entity of claim 22, wherein the one or more information elements comprises a first information element that indicates that the second subset of symbols comprises one or more downlink symbols, a second information element that indicates that the second subset of symbols comprises one or more uplink symbols, or both.

24. The network entity of claim 14, wherein the control signaling comprises medium access control-control element message, a downlink control information message, or both.

25. The network entity of claim 14, wherein the second symbol numerology is greater than the first symbol numerology, and wherein the second subcarrier spacing is greater than the first subcarrier spacing based at least in part on the second symbol numerology being greater than the first symbol numerology.

26. The network entity of claim 14, wherein each symbol in the first subset of symbols is associated with a first duration, and wherein each symbol in the second subset of symbols is associated with a second duration that is half of the first duration.

27. A method for wireless communications at a user equipment (UE), comprising:
communicating during a first slot in accordance with a first slot format, wherein, in accordance with the first slot format, each symbol of the first slot is associated with a first symbol numerology corresponding to a first subcarrier spacing;
receiving control signaling indicative of a switch from the first slot format to a second slot format; and
communicating during a second slot in accordance with the second slot format based at least in part on reception of the control signaling, wherein, in accordance with the second slot format, a first subset of symbols of the second slot is associated with the first symbol numerology and a second subset of symbols of the second slot is associated with a second symbol numerology corresponding to a second subcarrier spacing, and wherein the second symbol numerology is different from the first symbol numerology.

28. The method of claim 27, wherein the second slot comprises one or more downlink symbols, one or more uplink symbols, and a guard period between the one or more downlink symbols and the one or more uplink symbols in a time domain, and wherein the guard period comprises one or more symbols of the second subset of symbols associated with the second symbol numerology.

29. A method for wireless communications at a network entity, comprising:
communicating during a first slot in accordance with a first slot format, wherein, in accordance with the first slot format, each symbol of the first slot is associated with a first symbol numerology corresponding to a first subcarrier spacing;
transmitting control signaling indicative of a switch from the first slot format to a second slot format; and
communicating during a second slot in accordance with the second slot format based at least in part on transmission of the control signaling, wherein, in accordance with the second slot format, a first subset of symbols of the second slot is associated with the first symbol numerology and a second subset of symbols of the second slot is associated with a second symbol numerology corresponding to a second subcarrier spacing, and wherein the second symbol numerology is different from the first symbol numerology.

30. The method of claim 29, wherein the second slot comprises one or more downlink symbols, one or more uplink symbols, and a guard period between the one or more downlink symbols and the one or more uplink symbols in a time domain, and wherein the guard period comprises one or more symbols of the second subset of symbols associated with the second symbol numerology.
